(19) United States
(12) Patent Application Publication
(10) Pub. No.: US 2019/0308482 A1
(43) Pub. Date: Oct. 10, 2019

(54) SURROUNDINGS MONITORING APPARATUS

(71) Applicant: AISIN SEIKI KABUSHIKI KAISHA, Kariya-shi (JP)

(72) Inventors: Kinji YAMAMOTO, Anjo-shi (JP); Tetsuya MARUOKA, Okazaki-shi (JP); Kazuya WATANABE, Anjo-shi (JP); Itsuko FUKUSHIMA, Nagoya-shi (JP)

(73) Assignee: AISIN SEIKI KABUSHIKI KAISHA, Kariya-shi (JP)

(21) Appl. No.: 16/379,190

(22) Filed: Apr. 9, 2019

(30) Foreign Application Priority Data
Apr. 10, 2018 (JP) 2018-075479
Apr. 10, 2018 (JP) 2018-075604

(51) Int. Cl. B60G 17/0165; G06K 9/00

(52) U.S. Cl. CPC B60G 17/0165; B60G 2400/252; G06K 9/00791

(57) ABSTRACT

A surroundings monitoring apparatus includes a display control unit which displays a state where a vehicle height serving as a height of a vehicle is changing on a screen of a display portion in a case where the vehicle height is changing.

### CROSS REFERENCE TO RELATED APPLICATIONS

This application is based on and claims priority under 35 U.S.C. § 119 to Japanese Patent Application 2018-075479, filed on Apr. 10, 2018, and Japanese Patent Application 2018-075604, filed on Apr. 10, 2018, the entire contents of which are incorporated herein by reference.

### TECHNICAL FIELD

This disclosure generally relates to a surroundings monitoring apparatus.

### BACKGROUND DISCUSSION

A technique for displaying an overhead view image at a monitor mounted at an inside of a vehicle is known, for example, the overhead view image being obtained by combining a captured image capturing surroundings of the vehicle and an image showing an external appearance of the vehicle. Another technique is also known for changing the image showing the external appearance of the vehicle in a case where a tailgate (backdoor) of the vehicle is opened, for example, so that the changed image is displayed at the monitor. Such technique is disclosed in JP5522492B, JP2017-47782A, JP3906892B, and JP2016-184926A, for example.

According to the technique disclosed in each of JP5522492B, JP2017-47782A, JP3906892B, and JP2016-184926A, in a case where a height of the vehicle is changing, a user may have difficulty in recognizing such change.

A need thus exists for a surroundings monitoring apparatus which is not susceptible to the drawback mentioned above.

### SUMMARY

According to an aspect of this disclosure, a surroundings monitoring apparatus includes a display control unit which displays a state where a vehicle height serving as a height of a vehicle is changing on a screen of a display portion in a case where the vehicle height is changing.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating an example of a vehicle interior which is partially viewed through a vehicle body according to a first embodiment disclosed here;

FIG. 2 is a diagram illustrating an example of a hardware configuration of a vehicle control system including an ECU according to the first embodiment;

FIG. 3 is a block diagram illustrating an example of functions of the ECU according to the first embodiment;

FIG. 4 is a flowchart illustrating an example of procedures of display processing for vehicle height change according to the first embodiment;

FIGS. 5A, 5B and 5C are diagrams each illustrating an example of a display which shows increase of vehicle height according to the first embodiment;

FIGS. 6A, 6B and 6C are diagrams each illustrating an example of a display which shows decrease of vehicle height according to the first embodiment;

FIGS. 7A, 7B and 7C are diagrams each illustrating an example of a display of a bar according to the first embodiment;

FIGS. 8A and 8B are diagrams each illustrating another example of the display of the bar according to the first embodiment;

FIG. 9 is a flowchart illustrating an example of procedures of display processing for vehicle height change according to a second embodiment disclosed here;

FIG. 10 is a diagram illustrating an example of a display which shows increase of vehicle height according to the second embodiment;

FIG. 11 is a diagram illustrating an example of a display which shows decrease of vehicle height according to the second embodiment;

FIGS. 12A and 12B are diagrams each illustrating an example of a screen which displays turning-on of a rear fog lamp according to a first modified example disclosed here;

FIG. 13 is a diagram illustrating an example of usage of a bar according to a second modified example disclosed here;

FIG. 14 is a block diagram illustrating an example of functions of an ECU according to a fourth modified example disclosed here;

FIG. 15 is a flowchart illustrating an example of procedures of screen switching processing according to the fourth modified example;

FIG. 16 is a diagram illustrating an example of switching a viewpoint of a 3D view according to the fourth modified example;

FIG. 17 is a diagram illustrating an example of switching a screen according to the fourth modified example;

FIG. 18 is a block diagram illustrating an example of functions of an ECU according to a fifth modified example disclosed here;

FIG. 19 is a flowchart illustrating an example of procedures of screen switching processing according to the fifth modified example; and

FIG. 20 is a diagram illustrating an example of information obtained by correlating portions of the vehicle operated as changes of a state of the vehicle and viewpoints according to the fifth modified example.

### DETAILED DESCRIPTION

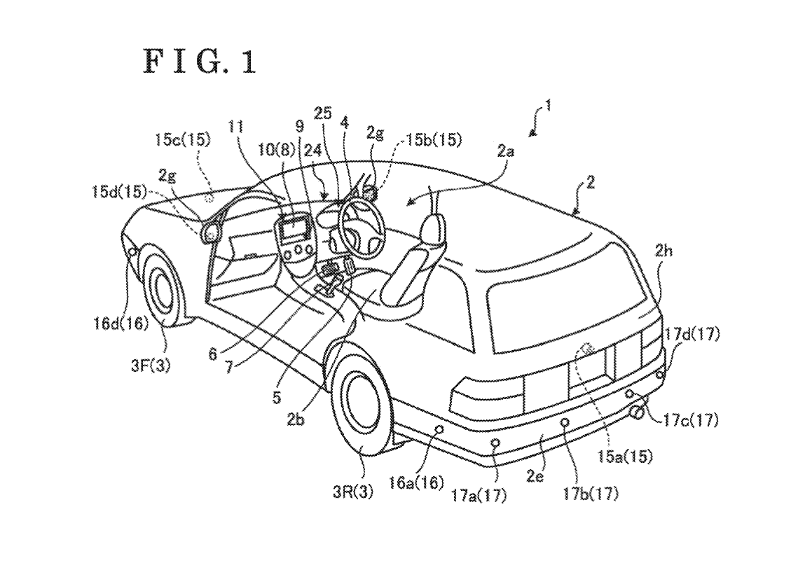

A first embodiment is explained with reference to FIGS. 1 to 8. As illustrated in FIG. 1, a vehicle body 2 constitutes a vehicle interior 2a where a passenger is in. Within the vehicle interior 2a, a steering portion 4, an accelerating portion 5, a braking portion 6, and a gear change portion 7, for example, are provided in a state of being opposed to a seat 2b for a driver serving as a passenger.

The steering portion 4 is a steering wheel (a steering handle) protruding from a dashboard 24, for example. The accelerating portion 5 is an accelerator pedal, for example. The braking portion 6 is a brake pedal, for example. The gear change portion 7 is a shift lever, for example.

Within the vehicle interior 2a, a display device 8 and an audio output device 9 are provided, for example. The audio output device 9 is a speaker, for example. The display device 8 is a liquid crystal display (LCD) and an organic electroluminescent display (OELD), for example. The display device 8 is an example of a display portion in the embodiment. The display device 8 is covered by an operation input portion 10 which is transparent such as a touch panel, for example. A passenger may perform an operation input by pressing down the operation input portion 10 with one's finger, for example, at a position corresponding to an image displayed at a display screen of the display device 8.

The display device 8, the audio output device 9, and the operation input portion 10, for example, are provided at a monitor device 11. The monitor device 11 may include an operation input portion such as a switch and a pressing button, for example. In addition, a display device (display portion) different from the display device 8 may be provided within the vehicle interior 2a. Various kinds of indicators are displayed at an instrument panel portion 25 at the dashboard 24.

As illustrated in FIG. 1, the vehicle body 2 is equipped with four imaging units 12b 15b, 15c, and 15d serving as plural imaging units (imaging devices) 15, for example. Each of the imaging units 15 is a digital camera incorporating an imaging element such as a charge coupled device (CCD) and a CMOS image sensor (CIS), for example, so as to output moving image data at a predetermined frame rate. The imaging units 15 sequentially capture images of outside environment around the vehicle body 2 including a road surface where the vehicle 1 is movable and an area where the vehicle 1 is able to be parked, and output such images as captured image data.

The imaging unit 15a is provided and positioned in the vicinity of a rear end portion 2e of the vehicle body 2, i.e., at a wall portion of the vehicle body 2 below a rear window of a door 2h of a rear hatch, for example. The imaging unit 15b is provided and positioned at a right end portion of the vehicle body 2, i.e., at a right-side door mirror 2g, for example. The imaging unit 15c is provided and positioned at a front side of the vehicle body 2, i.e., at a front end portion of the vehicle body 2 in a front-rear direction of the vehicle. The imaging unit 15d is provided and positioned at a left end portion of the vehicle body 2, i.e., at a left-side door mirror 2g, for example. The number of imaging units 15 and positions thereof are not limited to the above.

As illustrated in FIG. 1, the vehicle 1 is a four-wheel automobile, for example, while including right and left front wheels 3F and right and left rear wheels 3R. The aforementioned four wheels 3 are steerable. The number, configuration, system, and layout, for example, of each device related to driving of the wheels 3 in the vehicle 1 may be variously specified.

As illustrated in FIG. 1, the vehicle body 2 is equipped with plural distance measuring units 16a, 16d (distance measuring units 16), 17a, 17b, 17c, and 17d (distance measuring units 17). Each of the distance measuring units 16 and 17 is a sonar (a sonar sensor or an ultrasonic detector) emitting ultrasonic wave and capturing a reflected wave, for example. The number and positions of the distance measuring units 16 and 17 mounted at the vehicle body 2 are not limited to the example illustrated in FIG. 1.

In the present embodiment, the height of the vehicle 1 (vehicle height) is changeable in three modes, i.e., a low mode, a normal mode, and a high mode. That is, the height of the vehicle 1 is changeable to “low”, “normal”, and “high”. A vehicle height adjustment mechanism for adjusting the height of the vehicle 1 is constituted by a known suspension, for example.

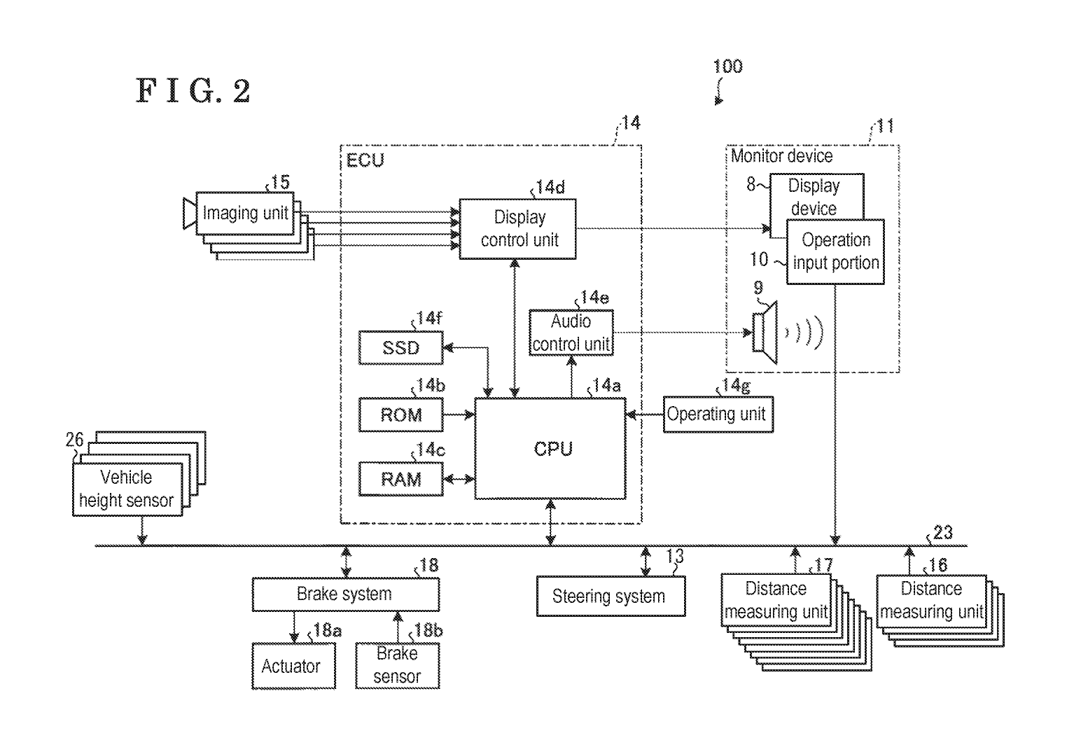

As illustrated in FIG. 2, a vehicle control system 100 includes an electronic control unit (ECU) 14, the monitor device 11, a steering system 13, the distance measuring units 16, 17, a brake system 18, and vehicle height sensors 26, for example, which are electrically connected to one another via an in-vehicle network 23 serving as an electrical communication line. The in-vehicle network 23 is constituted as a controller area network (CAN), for example.

The ECU 14 transmits a control signal via the in-vehicle network 23 to control the steering system 13 and the brake system 18, for example. The ECU 14 receives detection results of a brake sensor 18b and the vehicle height sensors 26, for example, and an instruction signal (a control signal, an operation signal, an input signal, and data) of the operation input portion 10, for example, via the in-vehicle network 23. The ECU 14 serves as an example of a surroundings monitoring apparatus in the first embodiment.

The ECU 14 includes a central processing unit (CPU) 14a, a read only memory (ROM) 14b, a random access memory (RAM) 14c, a display control unit 14d, an audio control unit 14e, and a solid state drive (SSD) (flash memory) 14f, for example.

The CPU 14a reads out program installed and stored at a non-volatile storage unit such as the ROM 14b, for example, and performs an arithmetic processing based on such program. The CPU 14a also obtains an operation signal resulting from an operation input relative to an operating unit 14g and signals from various sensors. The display control unit 14d controls an image output relative to the display device 8. The audio control unit 14e mainly performs processing on audio data output from the audio output device 9 among the arithmetic processing performed at the ECU 14.

The CPU 14a, the ROM 14b, and the RAM 14c, for example, may be integrated within the same package. The ECU 14 may be constructed to use another arithmetic logic processor or logic circuit such as a digital signal processor (DSP), for example, instead of the CPU 14a. In addition, a hard disk drive (HDD) may be provided instead of the SSD 14f, or the SSD 14f and the HDD may be provided separately from the ECU 14, for example.

The operating unit 14g is a device outputting an operation signal by receiving an operation from a user. For example, the operating unit 14g is constituted by a pressing button or a switch. The height of the vehicle 1 is selectable from the three modes, i.e., the low mode, the normal mode, and the high mode via the operating unit 14g of the present embodiment. The operating unit 14g is provided at the dashboard 24, for example.

The steering system 13 steers at least two wheels 3. The brake system 18 includes an actuator 18a and the brake sensor 18b. The brake system 18 applies a braking force to the wheels 3 and to the vehicle 1 via the actuator 18a.

The vehicle height sensors 26 are provided in the vicinity of the respective wheels 3 to detect the height of the vehicle body 2 from a ground surface. In the vehicle 1 of the present embodiment, the four vehicle height sensors 26 are provided at the four wheels 3, respectively. The vehicle height sensor 26 transmits a detection signal indicating a detection result of the height of the vehicle body 2 to the ECU 14. The detection signal is an example of vehicle height information in the first embodiment. Constructions, arrangements, and electrical connections of the aforementioned sensors and actuators are examples and may be appropriately changed or specified.

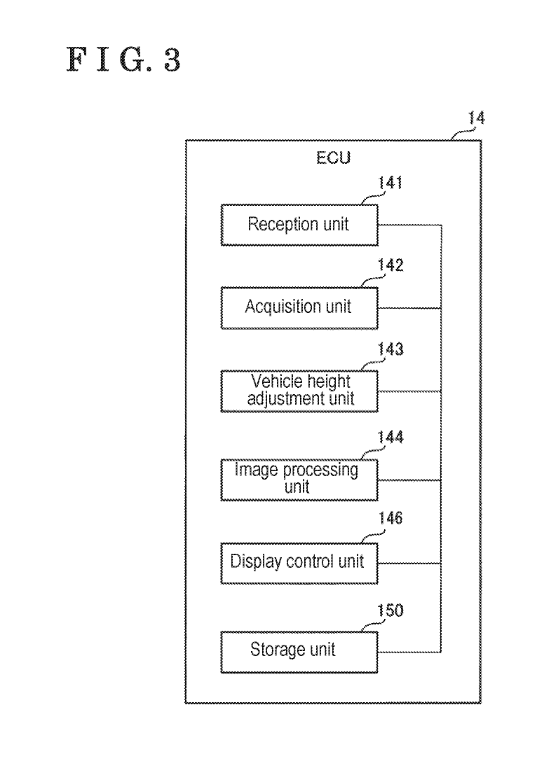

As illustrated in FIG. 3, the ECU 14 includes a reception unit 141, an acquisition unit 142, a vehicle height adjustment unit 143, an image processing unit 144, a display control unit 146, and a storage unit 150. Constructions of the reception unit 141, the acquisition unit 142, the vehicle height adjustment unit 143, the image processing unit 144, and the display control unit 146 are realized by the CPU 14a which executes program stored at the ROM 14b. Alternatively, the aforementioned constructions may be realized by a hardware circuit.

The storage unit 150 stores beforehand an icon image (which is hereinafter referred to as an icon) representing an external appearance of the vehicle 1. The icon in the embodiment is an image depicting the vehicle 1 from an obliquely upper side or a lateral side, for example. The storage unit 150 also stores a ghost representing a configuration of the vehicle body 2 of the vehicle 1. The ghost in the embodiment is an icon that is semitransparent. In a case where the ghost is displayed on the image, a background image of the ghost is displayed as penetrating through the ghost. The ghost is displayed at least in a manner that an outline of the vehicle body 2 of the vehicle 1 is visible (visually recognizable). The ghost may be also referred to as a transparent icon or a transparent image. The storage unit 150 stores an image showing an upper surface and a rear surface of the vehicle 1, for example. The icon, the ghost, and the image showing the upper surface and the rear surface of the vehicle 1 are generated beforehand by computer graphics (CG), for example. The storage unit 150 corresponds to the SSD 14f, for example.

The storage unit 150 stores respective heights of the imaging unit 15 from the ground surface in cases where the height of the vehicle 1 is low (in the low mode), normal (in the normal mode), and high (in the high mode) by correlating the heights of the imaging unit 15 from the ground surface to the respective vehicle heights.

The reception unit 141 receives an operation of a user for changing the vehicle height via the operation signal acquired from the operating unit 14g. The reception unit 141 may also receive an operation of a driver for changing the vehicle height from the operation input portion 10. Specifically, the reception unit 141 receives the operation of the user who selects either one of the low mode, the normal mode, and the high mode for the height of the vehicle 1 after the change.

The acquisition unit 142 acquires the height of the vehicle 1 based on detection signals input from the vehicle height sensors 26.

The vehicle height adjustment unit 143 changes the vehicle height by controlling the vehicle height adjustment mechanism in a case where the reception unit 141 receives the operation of the user for changing the vehicle height. Regardless of the operation of the user for changing the vehicle height, the vehicle height adjustment unit 143 changes the vehicle height conforming to each driving mode in a case where the driving mode of the vehicle 1 is changed.

The image processing unit 144 generates a three-dimensional (3D) view and an overhead view image by converting captured images captured by the imaging units 15 with a predetermined conversion content. The predetermined conversion content corresponds to conversion of viewpoint of the captured images by a predetermined angle and composition of plural captured images, for example. The 3D view is an image including a background image of surroundings of the vehicle 1 as viewed from an obliquely upper side or a lateral side, for example, and an icon representing the vehicle 1. The icon is stored beforehand at the storage unit 150. The overhead view image includes a background image of surroundings of the vehicle 1 as viewed from an upper side and an image of an upper surface of the vehicle 1. Specifically, the image processing unit 144 performs an image processing (conversion) on the captured images captured by the imaging units 15 such as combining the captured images and performing viewpoint conversion on the captured images, for example, to thereby generate the 3D view and the overhead view image. Details of the 3D view and the overhead view image are explained later.

In a case of changing the height of the vehicle 1, the display control unit 146 displays the icon representing the vehicle 1 at a position on the screen of the display device 8 corresponding to the height of the vehicle 1 before the height of the vehicle 1 is changed (before the change) on the screen (i.e., the icon is displayed at a first position on the screen of the display device 8). Alternatively, the display control unit 146 displays the icon representing the vehicle 1 at a position on the screen of the display device 8 corresponding to the height of the vehicle 1 after the height of the vehicle 1 is changed (after the change) on the screen (i.e., the icon is displayed at a second position on the screen of the display device 8). The display control unit 146 according to the present embodiment displays the icon representing the vehicle 1 at least at one of the first position and the second position. The icon displayed at the first position serves as an example of a first vehicle image and the icon displayed at the second position serves as an example of a second vehicle image in the first embodiment.

The display control unit 146 displays the ghost representing the vehicle 1 between the first position and the second position on the screen of the display device 8. The display control unit 146 repeatedly moves the ghost between a position on the screen corresponding to the height of the vehicle 1 before the change and a position on the screen corresponding to the height of the vehicle 1 after the change (i.e., a target height) in a direction where the height of the vehicle 1 is changing until the height of the vehicle 1 reaches the target height. The ghost serves as an example of a third vehicle image in the first embodiment. Each of the first vehicle image, the second vehicle image, and the third vehicle image at least represents the vehicle 1 and is not limited to the icon or the ghost. Details of display of the icon and the ghost are explained later. The display control unit 146 displays the 3D view and the overhead view image, for example, generated by the image processing unit 144 at the display device 8.

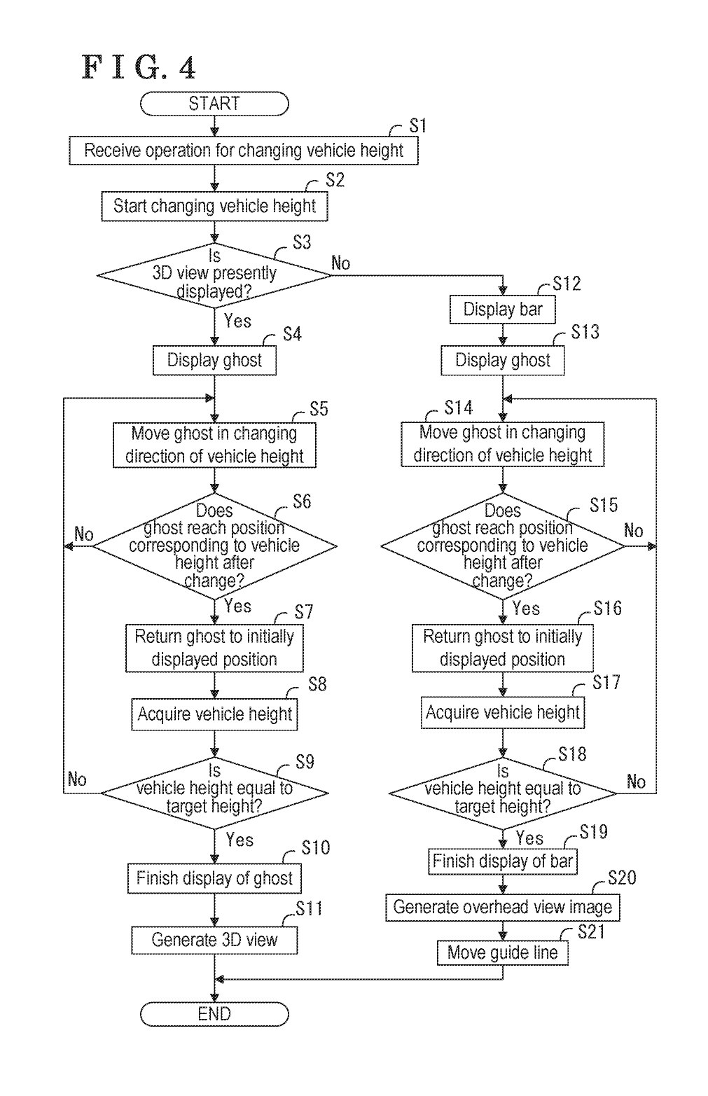

An example of procedures of display processing for vehicle height change according to the first embodiment is explained with reference to a flowchart in FIG. 4.

The reception unit 141 receives an operation of a user for changing the height of the vehicle 1 via the operation signal acquired from the operating unit 14g (S1). In this case, the vehicle height adjustment unit 143 starts changing the height of the vehicle 1 (S2). For example, in a case of the operation of the user for changing the height of the vehicle 1 to “high” while the height of the vehicle 1 before the change is “normal”, the vehicle height adjustment unit 143 starts increasing the vehicle height.

In a case of starting to change the height of the vehicle 1, the display control unit 146 determines whether or not the 3D view which includes the icon representing the vehicle 1 is presently displayed on the screen of the display device 8 (S3).

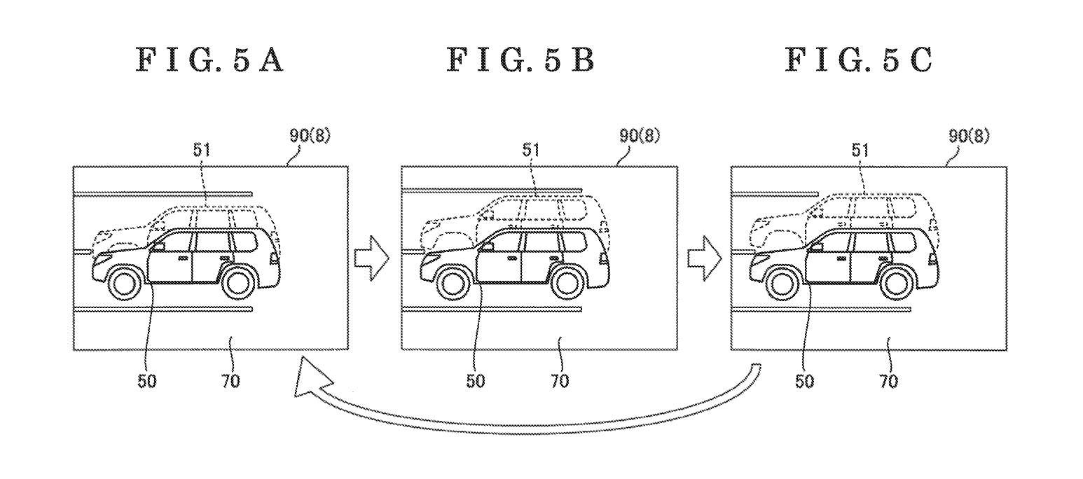

In a case where the 3D view is presently displayed (Yes at S3), the display control unit 146 displays the ghost representing the vehicle 1 on the 3D view (S4). The display of the icon and the ghost is explained with reference to FIGS. 5A to 5C.

FIGS. 5A to 5C illustrate an example of a display showing the increase of the height of the vehicle 1 according to the first embodiment. In FIGS. 5A to 5C, a 3D view 90 is displayed on the screen of the display device 8 when the height of the vehicle 1 is started to change. The 3D view 90 includes a background image 70 showing the surroundings of the vehicle 1 viewed from an obliquely upper side and an icon 50. The icon 50 is displayed at a position on the 3D view 90 corresponding to the height of the vehicle 1 before the change. The icon 50 is an image that is non-transparent. The background image 70 is an image generated by conducting the image processing such as composition and viewpoint conversion, for example, on the plural captured images. The 3D view 90 serves as an example of a first image in the embodiment. The first image is not limited to the 3D view 90 and may be an image indicating the icon 50 at the position corresponding to the height of the vehicle 1 before the change. The position of the icon 50 on the 3D view 90 is an example of the first position in the embodiment. The icon 50 is an example of the first vehicle image in the embodiment. The icon 50 may be also referred to as an index image indicating a position on the screen corresponding to the height of the vehicle 1 after the change.

The display control unit 146 displays a ghost 51 (serving as the example of the third vehicle image) representing the vehicle 1 so that the ghost 51 is superimposed on the icon 50 at an operation of S4. In the embodiment, the ghost 51 is displayed differently from the icon 50. Specifically, the ghost 51 is semitransparent so that the background is visible through the ghost 51. The ghost 51 is an image provided for indicating rising of the vehicle body 2 of the vehicle 1. Thus, the ghost 51 is an image including only an external appearance corresponding to the vehicle body 2 and excluding an image of the wheels 3.

Next, the display control unit 146 moves the ghost 51 in a changing direction of the height of the vehicle 1 (S5). In the example illustrated in FIGS. 5A to 5C, the reception unit 141 receives a signal for instructing the increase of the vehicle height by the user. In this case, because the height of the vehicle 1 increases, the display control unit 146 moves the ghost 51 upward as illustrated in FIGS. 5A to 5C. The display control unit 146 may change a moving speed of the ghost 51 depending on the height of the vehicle 1 before and after the change. For example, the display control unit 146 may further increase the moving speed of the ghost 51 in a case where the height of the vehicle 1 before the change is “low” and the height of the vehicle 1 after the change (i.e., a target vehicle height) is “high” than a case where the height of the vehicle 1 before the change is “normal” and the target vehicle height is “high”.

The display control unit 146 determines whether or not the ghost 51 reaches the position on the screen corresponding to the height of the vehicle 1 after the change (S6). In the example illustrated in FIGS. 5A to 5C, the position of the ghost 51 illustrated in FIG. 5C corresponds to the position on the screen corresponding to the vehicle position after the change, i.e., the second position in the embodiment. According to the embodiment, the position on the screen corresponding to the height of the vehicle 1 after the change is not a position conforming to an actual change amount of the height of the vehicle 1 and is a position at which the change amount is emphasized as being greater than the actual change amount. In a case where it is determined that the ghost 51 does not reach the position corresponding to the height of the vehicle 1 after the change (No at S6), the display control unit 146 returns the processing to S4 so as to continue to move the ghost 51 in the changing direction of the height of the vehicle 1.

In a case where it is determined that the ghost 51 reaches the position corresponding to the height of the vehicle 1 after the change (Yes at S6), the display control unit 146 returns the ghost 51 to an initially displayed (indicated) position, i.e., to a position corresponding to the height of the vehicle 1 before the change (S7).

The acquisition unit 142 acquires the height of the vehicle 1 (the vehicle height) based on detection signals input from the vehicle height sensors 26 (S8). The display control unit 146 determines whether or not the vehicle height acquired by the acquisition unit 142 matches the target vehicle height (S9). The target vehicle height is a target height of the vehicle 1 for the vehicle height change. In this case, the target vehicle height corresponds to the “high” height designated by the operation of the user. In a case where the height of the vehicle 1 does not match the target vehicle height (No at S9), the display control unit 146 repeats the operations from S4 to S9. By the aforementioned operations, the display control unit 146 repeatedly moves the ghost 51 in the changing direction of the height of the vehicle 1 between the position corresponding to the height of the vehicle 1 before the change and the position corresponding to the height of the vehicle 1 after the change until the vehicle height reaches the target height.

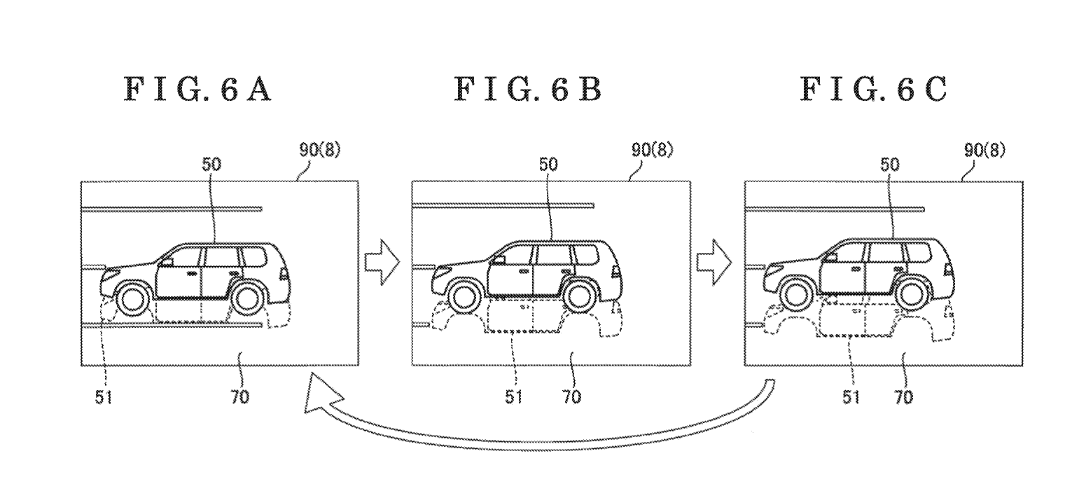

FIGS. 6A to 6C illustrate an example of a display showing the decrease of the height of the vehicle 1 according to the first embodiment. The example of the display illustrated in FIGS. 5A to 5C is the case where the height of the vehicle 1 increases. In a case where the height of the vehicle 1 decreases as illustrated in FIGS. 6A to 6C, the display control unit 146 repeatedly moves the ghost 51 in the changing direction of the height of the vehicle 1 from the position of the icon 50 to the position corresponding to the height of the vehicle 1 after the change until the vehicle height reaches the target height. In FIGS. 5A to 5C and 6A to 6C, the icon 50 is displayed at the position on the screen corresponding to the height of the vehicle 1 before the change. Alternatively, the display control unit 146 may display an icon indicating the vehicle 1 at a position on the screen corresponding to the height of the vehicle 1 after the change, instead of displaying the icon 50 at the position on the screen corresponding to the height of the vehicle 1 before the change.

In a case where the vehicle height matches the target vehicle height (Yes at S9), the display control unit 146 determines that the vehicle height adjustment is completed and terminates the display of the ghost 51 (S10). At this time, the display control unit 146 may move the icon 50 on the 3D view 90 to the position on the screen corresponding to the height of the vehicle 1 after the change.

Once the vehicle height adjustment is completed, the image processing unit 144 generates the 3D view 90 by converting the captured images with the conversion content depending on the height of each of the imaging units 15 conforming to the height of the vehicle 1 after the change (S11). The image processing unit 144 generates the 3D view 90 by conducting composition and viewpoint conversion on the captured images captured by the plural imaging units 15. In a case where the height of the imaging unit 15 changes from the height employed as a basis for the image processing, torsion may be generated at the 3D view 90. Thus, the image processing unit 144 acquires the height of the imaging unit 15 correlated to the height of the vehicle 1 after the change from the storage unit 150 so as to newly generate the 3D view by converting the captured images with the conversion content based on the acquired height of the imaging unit 15. The display control unit 146 renews (updates) a screen display by displaying the newly generated 3D view 90 by the image processing unit 144 at the screen of the display device 8.

In a case where the 3D view 90 is not being displayed at the start of changing the height of the vehicle 1 (No at S3), the display control unit 146 displays a bar including the icon 50 at the display device 8 (S12).

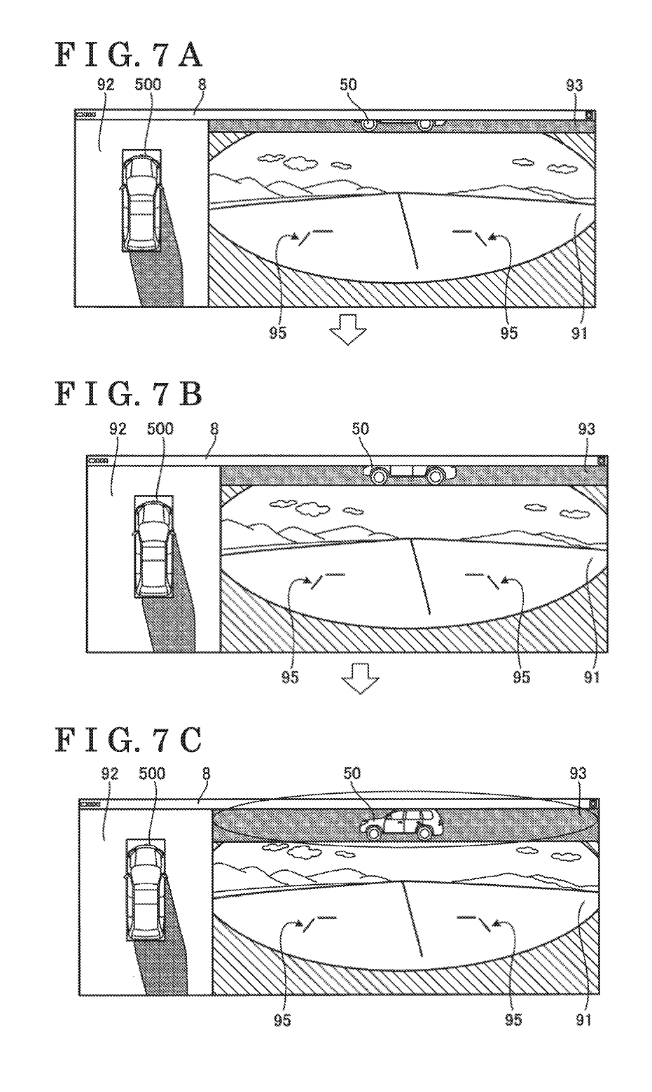

FIGS. 7A to 7C illustrate an example of a display of a bar 93. The bar 93 is an image in a band shape and serves as an example of a third image in the embodiment. In the example illustrated in FIGS. 7A to 7C, a camera view 91 displaying the captured image captured by any of the imaging units 15 and an overhead view image 92 where the vehicle 1 is viewed from an upper side are displayed on the screen of the display device 8. At the time the change of the vehicle height is started, the icon 50 is not displayed on the screen of the display device 8 and the image showing the vehicle 1 viewed from an angle at which the vehicle height is recognizable is not displayed on the screen of the display device 8. The overhead view image 92 is generated by the image processing unit 144 which performs composition and viewpoint conversion on the plural captured images captured by the plural imaging units 15. The overhead view image 92 includes an image 500 showing the vehicle 1 as viewed from an upper side. Each of the camera view 91 and the overhead view image 92 is an example of a second image in the embodiment. The camera view 91 may be the captured image converted with a predetermined conversion content by the image processing unit 144 or the captured image itself captured by the imaging unit 15.

As illustrated in FIG. 7A to 7C, the display control unit 146 gradually displays the bar 93 including the icon 50 of the vehicle 1 on the screen of the display device 8. Specifically, the display control unit 146 reduces the size of the camera view 91 or the overhead view image 92 in a stepwise manner in a state where the display of the camera view 91 or the overhead view image 92 is kept on the screen of the display device 8. Then, the display control unit 146 displays the bar 93 in a stepwise manner at an area which appears on the screen of the display device 8 by the reduction of the camera view 91 or the overhead view image 92. The display control unit 146 displays the icon 50 at a position on the bar 93 corresponding to the height of the vehicle 1 before the change. The display control unit 146 may display the icon 50 on the bar 93 at the start of displaying the bar 93 or after the bar 93 is entirely displayed.

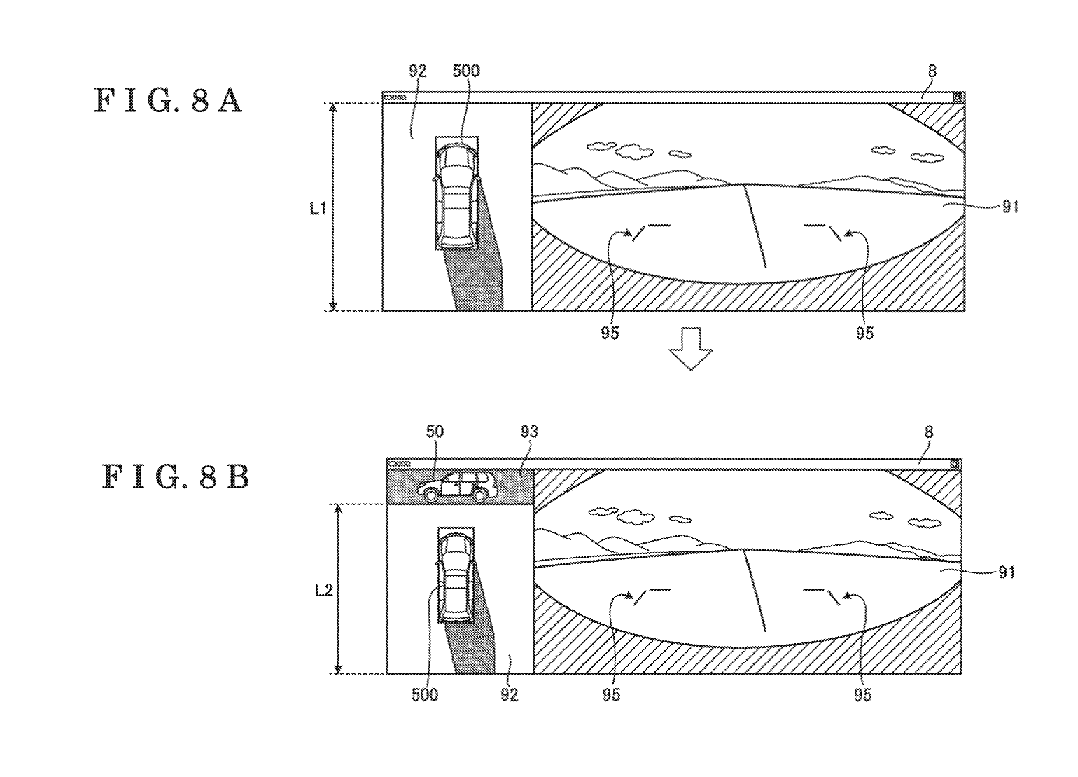

FIGS. 8A and 8B illustrate another example of a display of the bar 93 in the embodiment. As illustrated in FIGS. 8A and 8B, the display control unit 146 may display the bar 93 by reducing the size of the overhead view image 92. As illustrated in FIGS. 8A and 8B, the overhead view image 92 is reduced while a display content thereof is maintained, so that a display area of the bar 93 may be secured without reduction of a display range (a field of vision) of the overhead view image 92. In the example illustrated in FIGS. 7A to 7C, the display control unit 146 displays the bar 93 at the area on the screen of the display device 8 obtained by deleting an area excluding a road at an upper portion of the camera view 91. Alternatively, without changing a display content of the camera view 91, the entire camera view 91 may be reduced in a stepwise manner.

Back to the flowchart in FIG. 4, the display control unit 146 displays the ghost 51 on the bar 93 (S13). Operations from S14 at which the ghost 51 is moved to S18 at which it is determined whether or not the vehicle height matches the target vehicle height are the same as the aforementioned operations of S5 to S9.

In a case where the height of the vehicle 1 matches the target vehicle height (Yes at S18), the display control unit 146 determines that the vehicle height adjustment is completed and terminates the display of the bar 93 (S19). The display control unit 146 returns the size of each of the camera view 91 and the overhead view image 92 to the size obtained before the bar 93 is displayed.

Once the vehicle height adjustment is completed, the image processing unit 144 generates the overhead view image 92 by converting the captured images with the conversion content depending on the height of each of the imaging units 15 conforming to the height of the vehicle 1 after the change (S20). The overhead view image 92 is generated by the image processing for converting the captured images with the predetermined conversion content. Therefore, in a case where the height of each of the imaging units 15 changes from the height employed as a basis for the image processing performed by the image processing unit 144, torsion may be generated at the overhead view image 92. Thus, the image processing unit 144 acquires the height of the imaging unit 15 correlated to the height of the vehicle 1 after the change from the storage unit 150 so as to newly generate the overhead view image 92 by converting the captured images with the conversion content based on the acquired height of the imaging unit 15. The display control unit 146 renews (updates) a screen display by displaying the newly generated overhead view image 92 by the image processing unit 144 at the screen of the display device 8.

As illustrated in FIGS. 7A to 7C, guide lines 95 including a reference line indicating a distance from the vehicle 1 and a vehicle width line indicating the width of the vehicle 1 are displayed on the camera view 91. The position of the guide line 95 on the camera view 91 differs depending on the height of each of the imaging units 15. Thus, the display control unit 146 acquires the height of the imaging unit 15 correlated to the height of the vehicle 1 after the change from the storage unit 150 and moves the position of the guide line 95 based on the height of the imaging unit 15 corresponding to the height of the vehicle 1 after the change (S21). The guide line 95 serves an example of an index line in the embodiment. The index line may be another guide line indicating an estimated driving route of the vehicle 1, indicating a distance from an obstacle, or indicating a target parking position of the vehicle 1, for example. The index line is also referred to as index information. Once the movement of the guide line 95 is completed, the present processing is terminated.

In FIG. 4, the operation of the user for changing the height of the vehicle 1 serves as a trigger for starting the processing. The display processing for vehicle height change is also performed by following the operations in FIG. 4 in a case where the change of the height of the vehicle 1 is started because the driving mode of the vehicle 1 is changed, for example.

As mentioned above, the ECU 14 in the embodiment displays at least one of the icon 50 at the position on the screen of the display device 8 corresponding to the height of the vehicle 1 before the change and the icon at the position on the screen of the display device 8 corresponding to the height of the vehicle 1 after the change in a case of changing the height of the vehicle 1. In addition, the ECU 14 displays the ghost 51 between the position on the screen corresponding to the height of the vehicle 1 before the change and the position on the screen corresponding to the height of the vehicle 1 after the change. According to the ECU 14 of the embodiment, the icon indicating the vehicle 1 is displayed at the position on the screen corresponding to the height of the vehicle 1 before or after the change and at the position between the positions corresponding to the height of the vehicle 1 before and after the change. Thus, the user may easily recognize that the height of the vehicle 1 is changing.

Specifically, in a conventional apparatus, an indicator showing the change of the vehicle height is displayed at the instrument panel portion 25, for example, during the change of the vehicle height. According to such display, it may be difficult for a user to become aware of the change of the vehicle height. In addition, in a case where the height of the vehicle body of the icon 50 displayed at the display device 80 is simply changed, it may be difficult for a user to recognize the change of the vehicle height. On the other hand, according to the ECU 14 of the embodiment, the icon 50 or the ghost 51 representing the vehicle 1 is displayed at the position corresponding to the height of the vehicle 1 before or after the change and at the position between the positions corresponding to the heights of the vehicle 1 before and after the change. Thus, the change of the vehicle height is emphasized so that the user may easily realize and recognize that the vehicle height is changing.

According to the ECU 14 of the embodiment, the ghost 51 moves in the direction where the height of the vehicle 1 is changing until the vehicle height reaches the target height. Thus, the user may easily realize that the height of the vehicle 1 is increasing or decreasing.

In addition, according to the ECU 14 of the embodiment, the ghost 51 moves repeatedly in the changing direction of the height of the vehicle 1 between the position on the screen corresponding to the height of the vehicle 1 before the change and the position on the screen corresponding to the height of the vehicle 1 after the change until the vehicle height reaches the target height. Thus, because the ghost 51 continuously moves while the height of the vehicle 1 is changing, the user may easily realize that the height of the vehicle 1 is changing and the changing direction of the vehicle height.

Further, according to the ECU 14 of the embodiment, in a case where the 3D view 90 including the icon 50 is displayed on the screen of the display device 8 at the time the change of the height of the vehicle 1 is started, the ghost 51 is displayed on the 3D view 90. That is, while the display of the 3D view 90 that is originally displayed is being maintained, the display of the ghost 51 is added. Thus, the change of the height of the vehicle 1 is displayed on the screen without changing the 3D view 90 initially viewed by the user.

Further, according to the ECU 14 of the embodiment, in a case where the 3D view including the icon 50 is not displayed at the display device 8 at the time the change of the height of the vehicle 1 is started, the bar 93 including the icon 50 is first displayed at the display device 8 and then the ghost 51 is displayed on the bar 93. Therefore, even when the icon 50 is not displayed at the position on the screen corresponding to the height of the vehicle 1 before the change, the icon 50 and the ghost 51 are newly displayable on the screen.

Further, according to the ECU 14 of the embodiment, in a case where the bar 93 is displayed, the size of the camera view 91 or the overhead view image 92 is reduced in a stepwise manner in a state where the display of the camera view 91 or the overhead view image 92 which is originally displayed on the screen of the display device 8 is maintained, and the bar 93 is displayed in a stepwise manner at the area on the screen obtained by the reduction of the size of the camera view 91 or the overhead view image 92. Thus, the image indicating the change of the height of the vehicle 1 is displayed while the display of the camera view 91 or the overhead view image 92 which is already displayed on the screen is being maintained. In addition, because the bar 93 is displayed in a stepwise manner, the user may easily recognize or notice the newly displayed bar 93 and the display indicating the change of the height of the vehicle 1 on the bar 93.

Further, according to the ECU 14 of the embodiment, the ghost 51 is displayed differently from the icon 50 displayed at the position on the screen corresponding to the height of the vehicle 1 before the change and the icon displayed at the position on the screen corresponding to the height of the vehicle 1 after the change. Thus, the user may be inhibited from being confused by the icon displayed at the position on the screen corresponding to the height of the vehicle 1 before or after the change and the ghost 51 displayed on the screen during the change of the height of the vehicle 1.

Further, according to the ECU 14 of the embodiment, in a case where the guide line 95 is displayed on the screen of the display device 8 at the time the change of the height of the vehicle 1 is started, the display position of the guide line 95 is moved, after the vehicle height is changed to the target height, so as to conform to the height of the imaging unit 15 obtained after the height of the vehicle 1 is changed. Thus, a difference or a displacement of the display position of the guide line 95 on the screen caused by the change of the height of the imaging unit 15 depending on the change of the vehicle height is correctable.

Further, according to the ECU 14 of the embodiment, the overhead view image 92 is generated by converting the captured images with the conversion content depending on the height of the imaging unit 15 after the height of the vehicle 1 is changed to the target height. Thus, a torsion of the overhead view image 92 caused by the change of the height of the imaging unit 15 because of the change of the vehicle height may be eliminated.

In the first embodiment, the ECU 14 repeatedly moves the ghost 51 between the position on the screen corresponding to the vehicle height before the change and the position on the screen corresponding to the vehicle height after the change. In a second embodiment, the ECU 14 gradually moves the ghost 51 depending on the change of the vehicle height while the vehicle height is changing.

The constructions of the vehicle 1 in the second embodiment are similar to those of the vehicle 1 in the first embodiment. The ECU 14 in the second embodiment includes the reception unit 141, the acquisition unit 142, the vehicle height adjustment unit 143, the image processing unit 144, the display control unit 146, and the storage unit 150 in the same manner as the first embodiment. The reception unit 141, the acquisition unit 142, the vehicle height adjustment unit 143, the image processing unit 144, the display control unit 146, and the storage unit 150 include the same functions as those of the first embodiment.

The display control unit 146 in the second embodiment, which includes the same function as that of the first embodiment, moves the ghost 51 towards the position on the screen corresponding to the vehicle height after the change based on the vehicle height acquired by the acquisition unit 142.

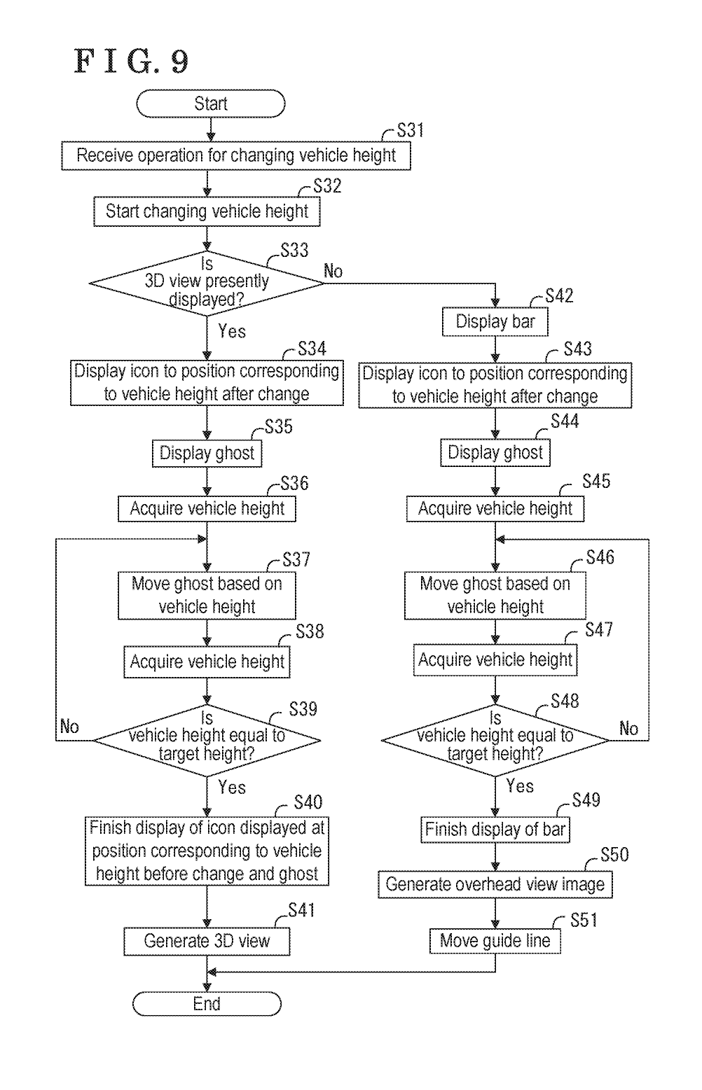

An example of procedures of display processing for vehicle height change according to the second embodiment is explained with reference to a flowchart in FIG. 9. Operations from S31 at which the operation for changing the vehicle height is received to S33 at which it is determined whether or not the 3D view 90 is presently displayed are the same as the operations from S1 to S3 in FIG. 4.

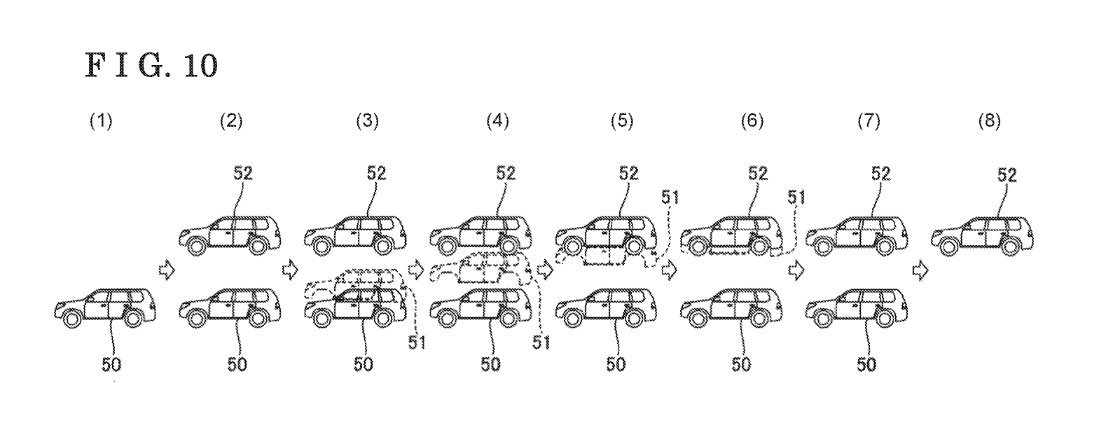

In a case where the 3D view is presently displayed (Yes at S33), the display control unit 146 displays the icon representing the vehicle 1 at the position on the 3D view 90 corresponding to the height of the vehicle 1 after the change (S34). FIG. 10 illustrates an example of a display showing the increase of the vehicle height according to the second embodiment. The background image 70 as illustrated in FIGS. 5A to 5C is generally displayed around the icon 50 in FIG. 10 though it is omitted in FIG. 10. The icon 50 in FIG. 10 is displayed at the position on the 3D view 90 corresponding to the vehicle height before the change. The icon 50 is already displayed on the 3D view 90. The display control unit 146 displays an icon 52 at the position on the 3D view 90 corresponding to the vehicle height after the change as illustrated in status (2) in FIG. 10. In FIG. 10, the vehicle height after the change is emphasized as compared to the actual vehicle height after the change. As long as the change of the vehicle height is recognizable by the user, any position of the icon 52 on the 3D view 90 is acceptable. The icon 52 is an example of the second vehicle image in the second embodiment. The icon 52 is also referred to as the index image indicating the position on the screen corresponding to the vehicle height after the change.

Next, the display control unit 146 displays the ghost 51 on the 3D view 90 (S35). For example, the display control unit 146 displays the ghost 51 in a superimposed manner at the position on the 3D view 90 corresponding to the vehicle height before the change as illustrated in status (3) FIG. 10.

At this time, the acquisition unit 142 acquires the vehicle height (S36). The display control unit 146 moves the ghost 51 towards the icon 52 based on the vehicle height acquired by the acquisition unit 142 (S37). Specifically, the display control unit 146 determines the position of the ghost 51 based on a degree of progress of the vehicle height change. For example, the display control unit 146 determines the degree of progress of the vehicle height change by calculating a ratio of a length from the vehicle height before the change to the vehicle height acquired by the acquisition unit 142 relative to a length from the vehicle height before the change to the target vehicle height. In a case where the present vehicle height acquired by the acquisition unit 142 is positioned at an intermediate point between the vehicle height before the change and the target vehicle height, the display control unit 146 moves the ghost 51 to an intermediate point between the icon 50 and the icon 52. The ghost 51 in the second embodiment is also referred to as the index image indicating the position on the screen corresponding to the present vehicle height.

The acquisition unit 142 again acquires the vehicle height (i.e., the present vehicle height) (S38). The display control unit 146 determines whether or not the vehicle height acquired by the acquisition unit 142 matches the target vehicle height (S39). In the case where the vehicle height is inhibited from matching the target vehicle height (No at S39), the display control unit 146 repeats the operations from S37 to S39.

In a case where the vehicle height matches the target vehicle height (Yes at S39), the display control unit 146 determines that the vehicle height adjustment is completed and terminates the display of the icon 50 and the ghost 51 displayed at the position on the screen corresponding to the vehicle height after the change (S40). As illustrated in status (8) in FIG. 10, the display control unit 146 keeps displaying the icon 52 at the position on the screen corresponding to the vehicle height after the change. The update of the 3D view 90 at S41 is the same as the operation at S11 in FIG. 4.

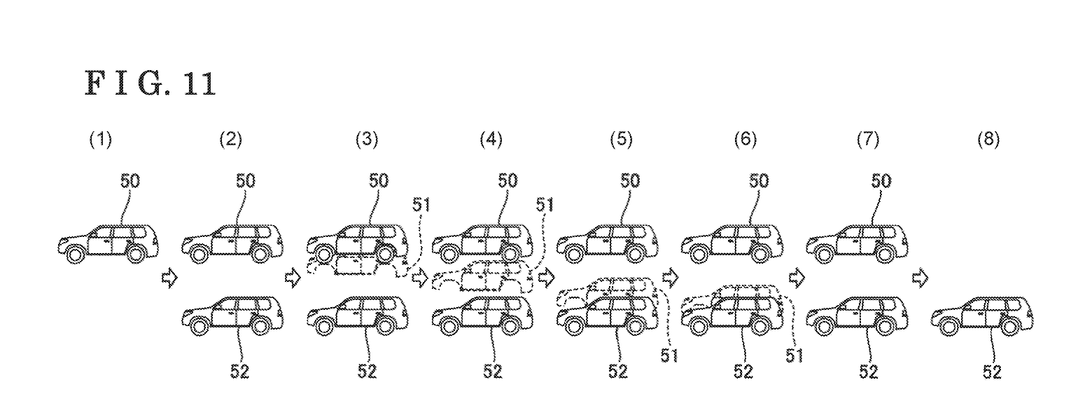

FIG. 11 illustrates an example of a display showing the decrease of the vehicle height according to the second embodiment. The example of the display illustrated in FIG. 10 is the case where the vehicle height increases. In a case where the vehicle height decreases as illustrated in FIG. 11, the display control unit 146 moves the ghost 51 from the position of the icon 50 towards the position of the icon 52 depending on the degree of progress of the vehicle height change. In FIGS. 10 and 11, the display control unit 146 displays both the icon 50 and icon 52. Alternatively, in FIGS. 10 and 11, the display control unit 146 may display either the icon 50 or the icon 52.

In a case where the 3D view 90 is not displayed at the time the change of the vehicle height is started (No at S33), the display control unit 146 displays the bar 93 including the icon 50 on the screen of the display device 8 (S42). The method of displaying the bar 93 is the same as the operation at S12 explained with reference to FIGS. 7 and 8.

Next, the display control unit 146 displays the icon 52 at the position on the bar 93 corresponding to the vehicle height after the change (S43). The display control unit 146 displays the ghost 51 on the bar 93 (S44).

Operations from S45 at which the vehicle height is acquired to S48 at which it is determined whether or not the vehicle height matches the target vehicle height are the same as the aforementioned operations from S36 to S39. In addition, operations from S49 at which the display of the bar 93 is terminated to S51 at which the guide line 95 is moved are the same as the operations from S19 to S21 in FIG. 4.

According to the ECU 14 of the second embodiment, during the change of the vehicle height, the ghost 51 is moved towards the position on the screen corresponding to the vehicle height after the change depending on the vehicle height acquired by the acquisition unit 142. Thus, because the ghost 51 is moved on a basis of the actual change of the vehicle height, the user may recognize the degree of progress of the vehicle height change in addition to easily recognizing that the vehicle height is changing as in the first embodiment.

In the aforementioned first and second embodiments, the bar 93 is utilized for the display of the change of the vehicle height. Alternatively, the bar 93 may be employed for other purposes.

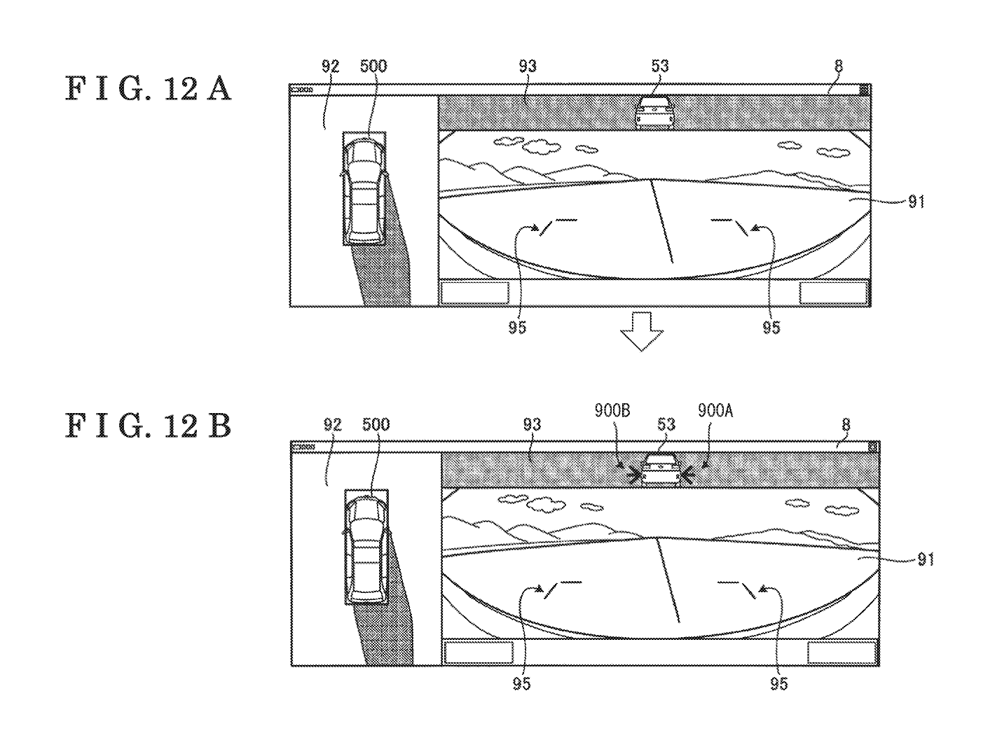

For example, FIGS. 12A and 12B illustrate an example of a screen displaying turning-on of rear fog lamps according to a first modified example. In a case where the rear fog lamps of the vehicle 1 are turned on, the display control unit 146 according to the first modified example displays the bar 93 as illustrated in FIG. 12A. An icon 53 indicating a rear face of the vehicle 1 is displayed on the bar 93. The display control unit 146 displays symbols 900A and 900B indicating turning-on of the lamps in the vicinity of positions at the icon 53 on the bar 93 corresponding to the rear fog lamps. Not limited to the turning-on of the rear fog lamps, the display control unit 146 may display an image showing the state of the vehicle 1 such as opening and closing of a door, for example, on the bar 93. As a result, while the camera view 91 or the overhead view image 92 which is originally displayed is maintained, the change of the state of the vehicle 1 such as turning-on of the rear fog lamps is recognizable by the user.

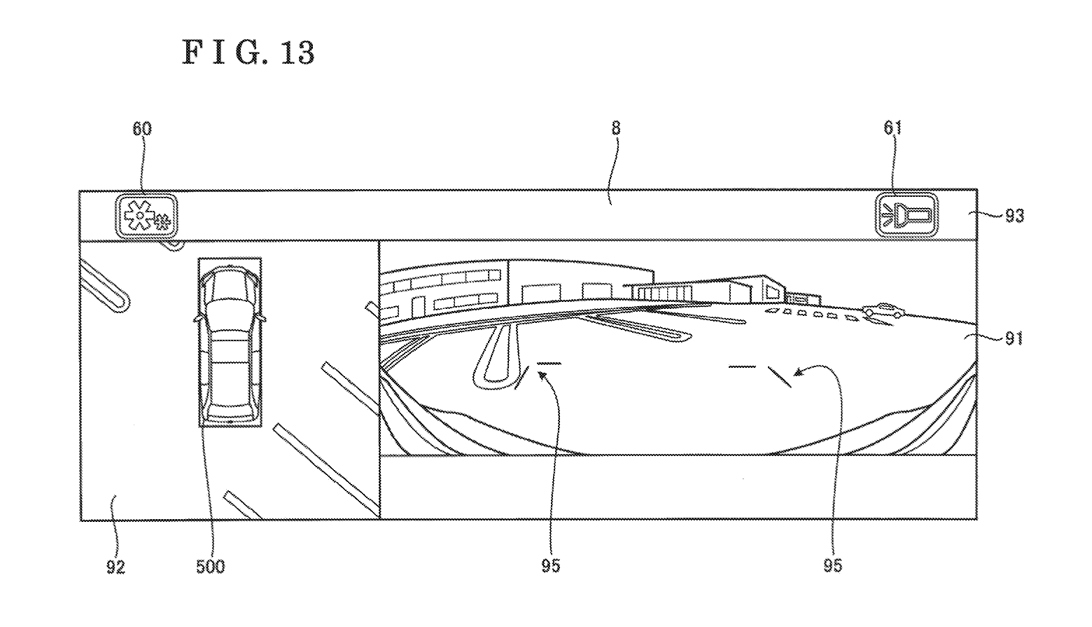

FIG. 13 illustrates an example of usage of the bar 93 according to a second modified example. As illustrated in FIG. 13, the display control unit 146 may display a setting button 60 via which various kinds of setting are changeable and an adjustment button 61 for adjusting brightness of the screen, for example. The display control unit 146 may also display a button for instructing on and off of the display of the guide line 95, or a menu button, for example. In the second modified example, the display control unit 146 displays the bar 93 based on an operation of a user such as touching and swipe on the operation input portion 10, for example. Because operation buttons such as the setting button 60 and the adjustment button 61, for example, are displayed on the display device 8 while the camera view 91 or the overhead view image 92 which is originally displayed on the screen is maintained, the user may confirm the camera view 91 or the overhead view image 92 and perform various operations at the same time.

According to a third modified example, a display mode of each of the ghost 51, the icon 50, and the icon 52 explained in the first and second embodiments may be changed depending on the vehicle height before and after the change.

For example, the display control unit 146 may change the display mode of the ghost 51 based on the vehicle height after the change (i.e., the target vehicle height). Specifically, the display control unit 146 may display the ghost 51 in different colors based on the target vehicle height. That is, the display control unit 146 may display the ghost 51 in red when the target vehicle height is “high”, display the ghost 51 in gray when the target vehicle height is “normal”, and display the ghost 51 in blue when the target vehicle height is “low”. The display control unit 146 may change the display mode of the ghost 51 depending on the vehicle height before the change even when the target vehicle height is the same.

The display control unit 146 may also change the display mode of the icon 50 or the icon 52 based on the vehicle height before and after the change. Specifically, the display control unit 146 may display the icon 50 in different colors based on the vehicle height before the change. That is, the display control unit 146 may display the icon 50 in blue when the vehicle height before the change is “low”, display the icon 50 in gray when the vehicle height before the change is “normal”, and display the icon 50 in red when the vehicle height before the change is “high”. In addition, for example, the display control unit 146 may display the icon 52 in different colors based on the vehicle height after the change. That is, the display control unit 146 may display the icon 52 in blue when the target vehicle height is “low”, display the icon 52 in gray when the target vehicle height is “normal”, and display the icon 52 in red when the target vehicle height is “high”.

According to the ECU 14 of the third modified example, the display mode of the ghost 51, the icon 50, or the icon 52 is changed depending on the vehicle height before and after the change. As a result, the target vehicle height or the vehicle height before or after the change may be easily recognizable by the user.

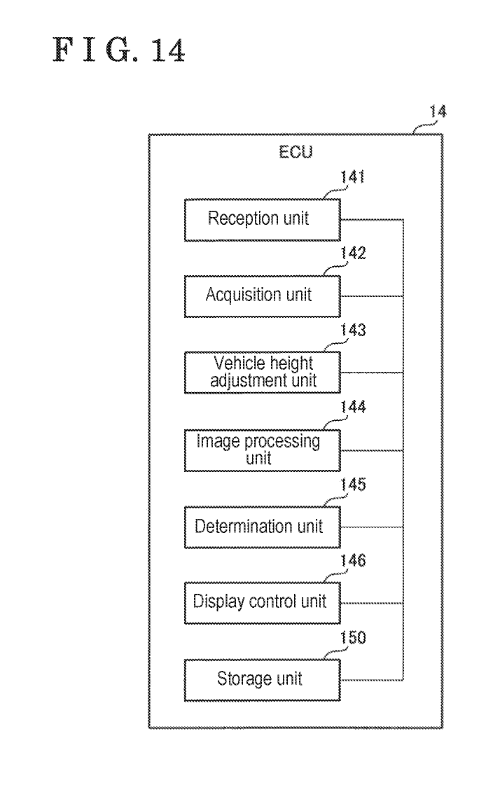

FIG. 14 is a block diagram illustrating an example of functions of the ECU 14 according to a fourth modified example. As illustrated in FIG. 14, the ECU 14 includes the reception unit 141, the acquisition unit 142, the vehicle height adjustment unit 143, the image processing unit 144, a determination unit 145, the display control unit 146, and the storage unit 150. Construction of the reception unit 141, the acquisition unit 142, the vehicle height adjustment unit 143, the image processing unit 144, the determination unit 145, the display control unit 146, and the storage unit 150 are realized by the CPU 14a executing program stored at the ROM 14b. Alternatively, the aforementioned constructions may be realized by a hardware circuit.

The storage unit 150 stores an icon image (which is hereinafter referred to as an icon) representing an external appearance of the vehicle 1. The icon is an image generated beforehand by computer graphics (CG), for example, and represents the external appearance of the vehicle 1 as viewed from various viewpoints (forward, obliquely forward, rearward, obliquely rearward, lateral, upward, and obliquely upward viewpoints, for example). The icon is an example of a three-dimensional (3D) image in the fourth modified example. The storage unit 150 corresponds to the SSD 14f, for example.

The reception unit 141 receives an operation of a user for changing the vehicle height via the operation signal acquired from the operating unit 14g. The reception unit 141 may also receive an operation of a driver for changing the vehicle height from the operation input portion 10. Specifically, the reception unit 141 receives the operation of the user who selects either one of the low mode, the normal mode, and the high mode for the vehicle height after the change.

The acquisition unit 142 acquires the height of the vehicle 1 based on detection signals input from the vehicle height sensors 26.

The vehicle height adjustment unit 143 changes the vehicle height by controlling the vehicle height adjustment mechanism in a case where the reception unit 141 receives the operation of the user for changing the vehicle height. Regardless of the operation of the user for changing the vehicle height, the vehicle height adjustment unit 143 changes the vehicle height conforming to each driving mode in a case where the driving mode of the vehicle 1 is changed.

The image processing unit 144 generates a composite image such as the 3D view, for example, by performing image processing such as composition and viewpoint conversion on the captured images captured by the imaging units 15. The 3D view includes a background image of surroundings of the vehicle 1 and the icon representing the external appearance of the vehicle 1. The background image is generated by the image processing on the captured images. In the fourth modified example, the icon serves as the example of the 3D image. Alternatively, the entire 3D view including the icon may serve as an example of the 3D image.

The determination unit 145 determines whether or not the vehicle height is changing. Specifically, in a case where the reception unit 141 receives an operation for changing the vehicle height, the determination unit 145 determines that the height of the vehicle 1 is changing. The determination unit 145 may also determine whether or not the vehicle height is changing by comparing the vehicle heights obtained by the acquisition unit 142 in chronological order.

At the time of the change of the state of the vehicle 1, the display control unit 146 adjusts the icon representing the vehicle 1, i.e., changes the outline of the icon representing the vehicle 1, for example, so that the adjusted icon conforms to the change of the state of the vehicle 1. In addition, the display control unit 146 displays a part of the icon corresponding to a portion of the vehicle 1 which is operated as the change of the state of the vehicle 1 at the display device 8 with a viewpoint with which the aforementioned part of the icon is displayable (i.e., recognizable at the display device 8). Specifically, in a case where the height of the vehicle 1 is changing, the display control unit 146 changes the height of the icon (icon's vehicle height) so that the height of the icon conforms to the height of the vehicle 1 that is changing and displays the icon representing the vehicle 1 with the viewpoint with which the change of the height of the icon conforming to the change of the height of the vehicle 1 is displayable. The height of the vehicle 1 (vehicle height) is an example of the state of the vehicle. In addition, the height of the vehicle 1 is an example of a portion of the vehicle 1 operated as the change of the state of the vehicle 1.

The viewpoint in the display of the 3D view is a viewpoint relative to the icon representing the vehicle 1 included in the 3D view. For example, the 3D view displaying the state where the icon is viewed from an obliquely upper side is referred to as the 3D view with the obliquely upward viewpoint. The viewpoint with which the change of the height of the icon is displayable is a viewpoint with which the change of the length of the icon in a vertical direction is displayed and is a viewpoint viewing the icon from an obliquely upper side or from a lateral side, for example. In a case where the 3D view is displayed with the viewpoint with which the change of the vehicle height is impossible to be displayed in a state where the vehicle height is changing, i.e., the 3D view is displayed with the upward viewpoint, for example, the display control unit 146 switches the viewpoint of the 3D view to the laterally upper viewpoint or the lateral viewpoint for displaying the 3D view.

The display control unit 146 displays the 3D view with the obliquely upward viewpoint or the lateral viewpoint in a case where the 3D view is not displayed at the display device 8 when the vehicle height is changing.

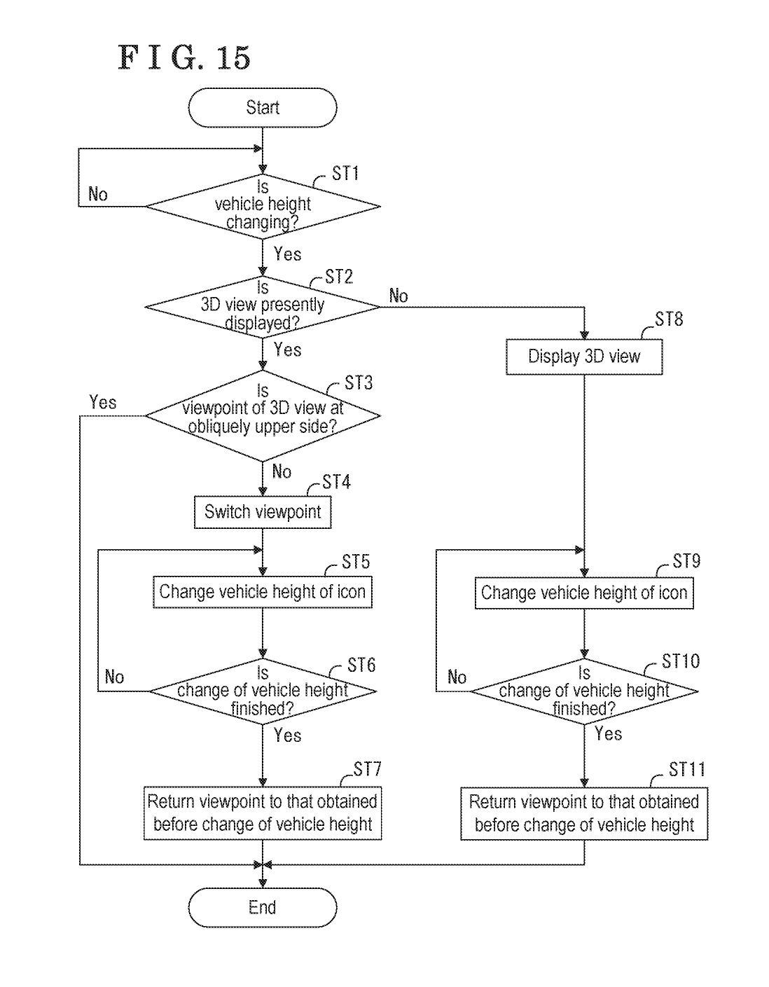

Next, details of image switching processing performed by the ECU 14 according to the fourth modified example constructed in the above are explained. An example of procedures of image switching processing according to the fourth modified example is explained with reference to a flowchart in FIG. 15. The procedures are started and performed in a state where the vehicle 1 is stopped, for example.

The determination unit 145 determines whether or not the height of the vehicle 1 is changing on a basis of whether or not the reception unit 141 receives the operation for changing the vehicle height or on a basis of the vehicle height acquired by the acquisition unit 142 (ST1). In a case where the determination unit 145 determines that the vehicle height is not changing (No at ST1), the determination unit 145 repeats the operation at ST1.

In a case where the determination unit 145 determines that the vehicle height is changing (Yes at ST1), the determination unit 145 notifies such determination to the display control unit 146. In this case, the display control unit 146 determines whether or not the 3D view is presently displayed at the display device 8 (ST2).

In a case where the 3D view is presently displayed (Yes at ST2), the display control unit 146 determines whether or not the viewpoint of the 3D view presently displayed is the viewpoint with which the change of the height of the icon is displayable. Specifically, the display control unit 146 determines whether or not the viewpoint of the 3D view presently displayed is the obliquely upward viewpoint (ST3). In a case where the viewpoint of the 3D view presently displayed is the obliquely upward viewpoint (Yes at ST3), the display control unit 146 continues the display of the 3D view presently displayed and terminates the present processing.

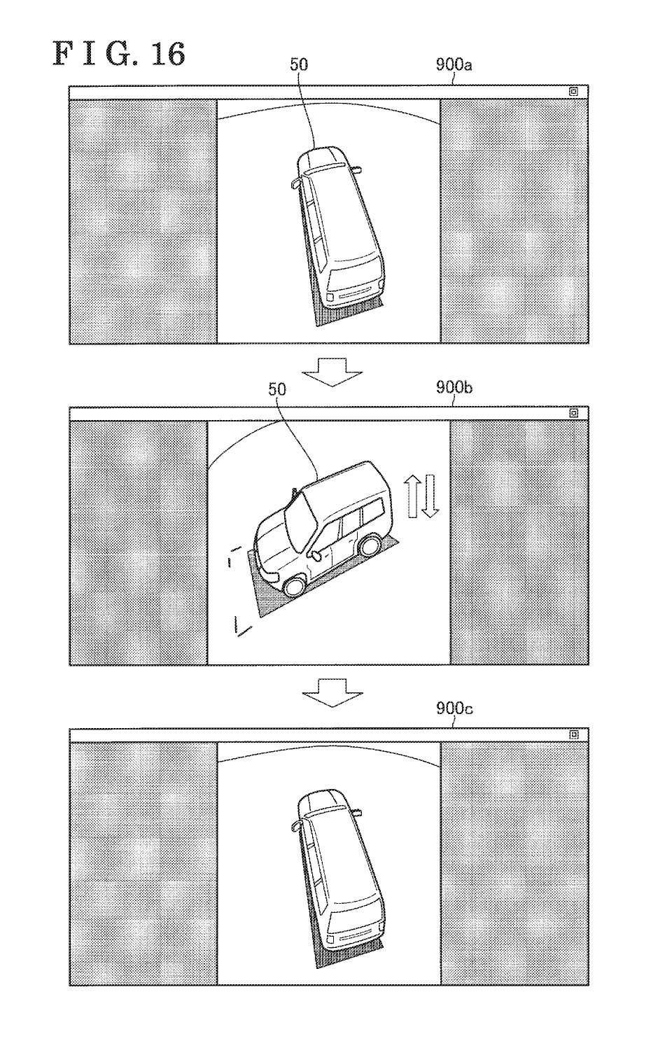

In a case where the viewpoint of the 3D view presently displayed is not the obliquely upward viewpoint (No at ST3), the display control unit 146 switches the viewpoint of the 3D view to the obliquely upward viewpoint. FIG. 16 illustrates an example of switching viewpoints of 3D views 900a, 900b, and 900c according to the fourth modified example. In the following, in a case where the 3D views 900a to 900c are not specifically distinguished from one another, the 3D views 900a to 900c are collectively referred to as a 3D view 900. In the example illustrated in FIG. 16, the 3D view 900a including the icon 50 (3D image) which represents the vehicle 1 is displayed at the display device 8 while the vehicle height is changing. In this case, because the 3D view 900a is displayed with the viewpoint viewing the icon 50 from an upper side, it is impossible to display the change of the height of the icon 50. Thus, the display control unit 146 switches the viewpoint of the 3D view to the obliquely upward viewpoint viewing the icon 50 from an obliquely upper side (ST4). The 3D view 900b shows the icon 50 which is displayed with the obliquely upward viewpoint.

The display control unit 146 changes the height of the icon 50 on the 3D view 900b based on the change of the height of the vehicle 1 (ST5). The display control unit 146 may increase or decrease the height of the icon 50 based on the actual change of the height of the vehicle 1 or as time proceeds.

Next, the determination unit 145 determines whether or not the change of the height of the vehicle 1 is completed (ST6). The determination unit 145 determines that the change of the height of the vehicle 1 is completed in a case where the vehicle height acquired by the acquisition unit 142 matches the target vehicle height obtained in the operation for changing the vehicle height received by the reception unit 141. Vehicle heights acquired by the acquisition unit 142 may be compared in chronological order and it may be determined that the change of the vehicle height is completed in a case where the vehicle height is not changed.

In a case where the determination unit 145 determines that the change of the vehicle height is not completed (No at ST6), the display control unit 146 returns the processing to ST5.

In a case where the determination unit 145 determines that the change of the vehicle height is completed (Yes at ST6), the display control unit 146 returns the viewpoint of the 3D view 900 displayed at the display device 8 to the viewpoint obtained before the change of the vehicle height (ST7). In the example illustrated in FIG. 16, the display control unit 146 changes (returns) the 3D view 900b with the obliquely upward viewpoint to the 3D view 900c with the upward viewpoint which is similar to the 3D view 900a.

In a case where the 3D view is not displayed when the height of the vehicle 1 is changing (No at ST2), the display control unit 146 displays the 3D view 900 with the obliquely upward viewpoint at the display device 8 (ST8).

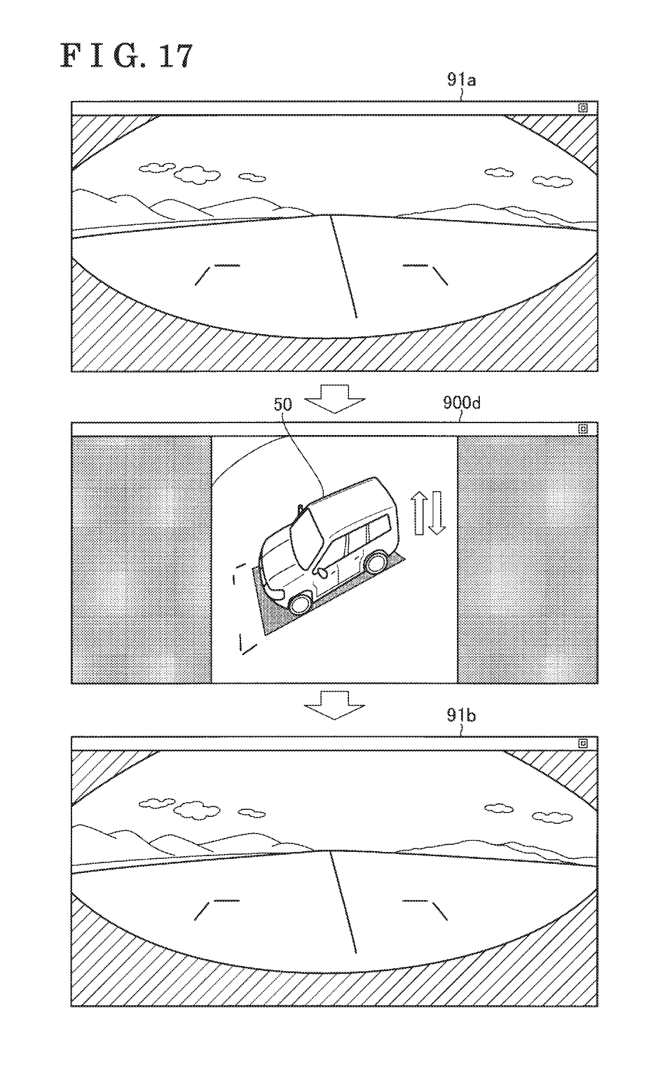

In an example illustrated in FIG. 17, an image other than the 3D view 900 is displayed, i.e., a camera view 91a serving as the captured image captured by the imaging unit 15, for example, is displayed at the display device 8 while the height of the vehicle 1 is changing. In this case, the display control unit 146 switches the display at the display device 8 from the camera view 91a to a 3D view 900d with the obliquely upward viewpoint.

In the same way as the operation at ST5, the display control unit 146 changes the height of the icon 50 on the 3D view 900d based on the change of the height of the vehicle 1 (ST9).

Next, the determination unit 145 determines whether or not the change of the height of the vehicle 1 is completed (ST10). In a case where the determination unit 145 determines that the change of the vehicle height is not completed (No at ST10), the display control unit 146 returns the processing to S9.

In a case where the determination unit 145 determines that the change of the vehicle height is completed (Yes at ST10), the display control unit 146 returns the screen of the display device 8 to the screen displayed before the change of the vehicle height (ST11). In the example illustrated in FIG. 17, the display control unit 146 returns the screen of the display device 8 from the 3D view 900d to the camera view 91b displayed before the change of the vehicle height (ST11). When the display of the display device 8 returns to the state before the change of the vehicle height, the present processing of the flowchart is terminated.

In the aforementioned flowchart, the display control unit 146 displays the 3D view 900 with the obliquely upward viewpoint in a case where the vehicle height is changing. Alternatively, the display control unit 146 may display the 3D view 900 with the lateral viewpoint.

According to the ECU 14 of the fourth modified example, the icon 50 representing the vehicle 1 is adjusted so as to conform to the change of the state of the vehicle 1 and is displayed at the display device 8 with the viewpoint with which a part of the icon 50 corresponding to a portion of the vehicle 1 operated as the change of the state of the vehicle 1 is displayable. Thus, according to the present ECU 14, when the state of the vehicle 1 is changed, the user may recognize the change of the state of the vehicle 1 based on the 3D view 900 displayed at the display device 8.

In a case where the state of the vehicle 1 is changed while the icon 50 is not being displayed at the display device 8, the 3D view 900 including the icon 50 becomes displayed at the display device 8. According to the ECU 14 of the fourth modified example, screen transition is performed in a case where the state of the vehicle 1 is changed, so that the 3D view 900 is displayed to thereby securely notify the user of the change of the state of the vehicle 1.

In addition, in a case where the vehicle height is changing, the 3D view 900 including the icon 50 is displayed at the display device 8, the 3D view 900 including the viewpoint with which the change of the height of the icon 50 is displayable. Thus, the user may securely recognize that the state of the vehicle 1 is changing.

Specifically, in a case of the change of the vehicle height, the 3D view 900 including the icon 50 with the obliquely upward viewpoint or the lateral viewpoint is displayed at the display device 8. Thus, the user may securely recognize that the state of the vehicle 1 is changing by the change of the length of the icon 50 in the vertical direction.

In the aforementioned fourth modified example, the viewpoint of the 3D view 900 is switched or the screen transition is performed in a case of the change of the vehicle height. In a fifth modified example, the viewpoint of the 3D view 900 is switched or the screen transition is performed in a case where the state of portions (items) other than the vehicle height is changed.

The entire construction of the vehicle 1 and the hardware construction of the vehicle control system 100 according to the fifth modified example are the same as those of the first embodiment explained with reference to FIGS. 1 and 2.

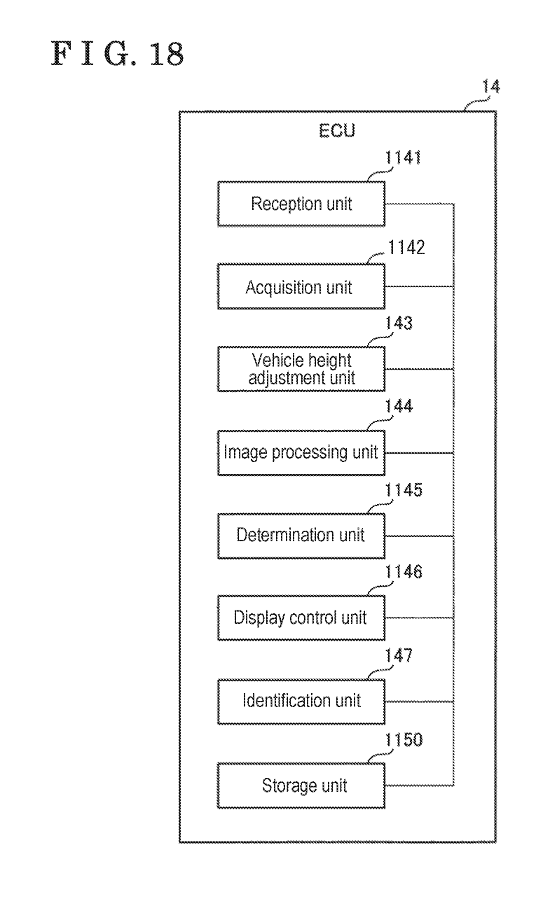

As illustrated in FIG. 18, the ECU 14 includes a reception unit 1141, an acquisition unit 1142, the vehicle height adjustment unit 143, the image processing unit 144, a determination unit 1145, a display control unit 1146, an identification unit 147, and a storage unit 1150. The reception unit 141, the vehicle height adjustment unit 143, and the image processing unit 144 include the same functions as those of the first embodiment.

The storage unit 1150 which stores information similar to that of the fourth modified example correlates and stores a portion of the vehicle 1 which is operated as the change of the state of the vehicle 1 and a viewpoint with which a part of the icon 50 corresponding to the aforementioned portion of the vehicle 1 is displayable. The correlation between the portion of the vehicle 1 operated as the change of the state of the vehicle 1 and the viewpoint are explained in detail later.

The acquisition unit 1142 that includes the same function as the fourth modified example acquires information indicating the change of each portion of the vehicle 1 via instruction signals transmitted from various sensors mounted at the vehicle 1 or the operation input portion 10, for example. Specifically, the acquisition unit 1142 acquires information of turning on/off of a headlamp, turning on/off of a fog lamp, an open/close of a side door, and an open/close of a tailgate (backdoor) from the various sensors or the instruction signals. The information acquired by the acquisition unit 1142 is not limited to the above.

The determination unit 1145 that includes the same function as the first embodiment determines whether or not any portion of the vehicle 1 is operated as the change of the state of the vehicle 1 based on the information acquired by the acquisition unit 1142. For example, the determination unit 1145 determines that the portion of the vehicle 1 is operated as the change of the state of the vehicle 1 in a case where the acquisition unit 1142 acquires the information indicating that the headlamp is turned on from a turned-off state.

The identification unit 147 identifies the viewpoint with which the part of the icon 50 corresponding to the portion of the vehicle 1 operated as the change of the state of the vehicle 1 is displayable on a basis of the correlation between the aforementioned portion of the vehicle 1 and the viewpoint stored at the storage unit 1150 in a case where the determination unit 1145 determines that the aforementioned portion of the vehicle 1 is operated. In a case where the plural portions of the vehicle 1 are operated as the changes of the state of the vehicle 1, the identification unit 147 identifies the viewpoint with which the plural parts of the icon 50 corresponding to the aforementioned respective portions of the vehicle 1 are displayable. In the fifth modified example, the plural portions of the vehicle 1 operated as the change of the state of the vehicle 1 include at least one of the headlamp, the fog lamp, the side door, and the tailgate (backdoor).

Even with the change of the state of the portion (item) other than the vehicle height, the display control unit 1146 including the same function as the first embodiment displays the icon 50 at the display device 8 with the viewpoint with which the part of the icon 50 corresponding to the portion of the vehicle 1 operated as the change of the state of the vehicle 1 is displayable. Specifically, the display control unit 1146 displays the icon 50 at the display device 8 with the viewpoint identified by the identification unit 147 with which the part of the icon 50 corresponding to the portion of the vehicle 1 operated as the change of the state of the vehicle 1 is displayable.

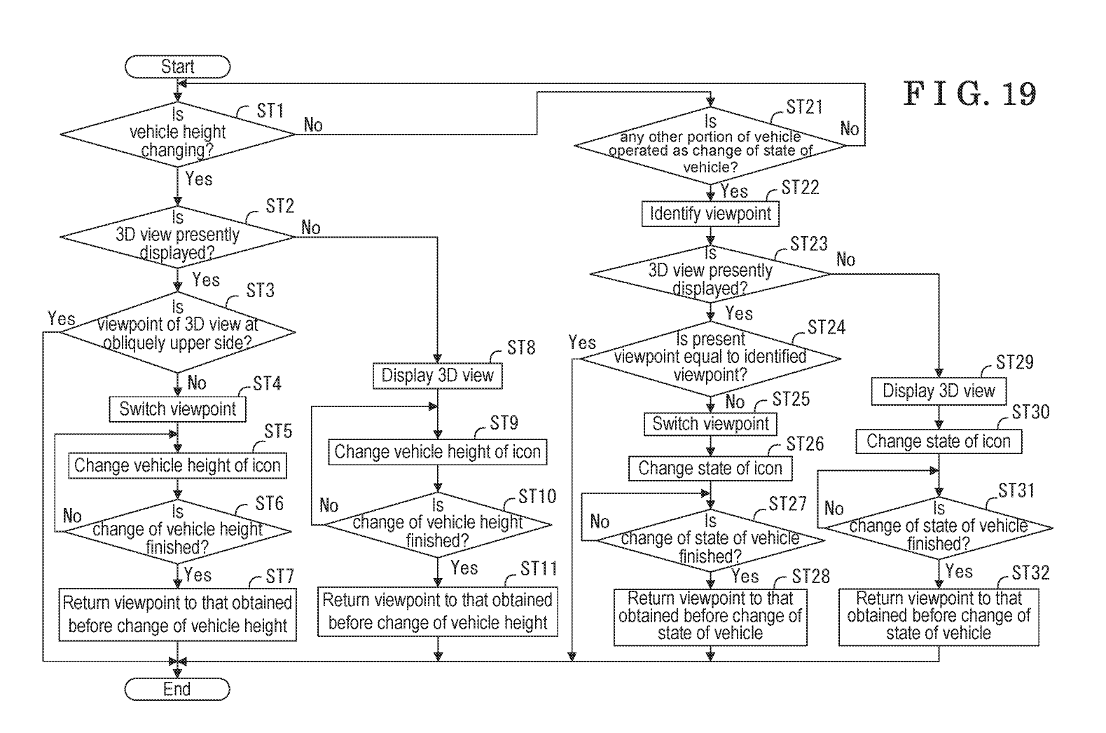

Next, details of the screen switching processing performed by the ECU 14 according to the fifth modified example constructed in the aforementioned manner are explained with reference to a flowchart illustrated in FIG. 19. Operations from the determination of whether or not the vehicle height is changing at ST1 to the processing for returning the screen to that obtained before the change of the vehicle height at ST11 in FIG. 19 are the same as the operations from ST1 to ST11 in FIG. 15.

In the fifth modified example, in a case where the determination unit 1145 determines that the vehicle height is not changing (No at ST1), the determination unit 1145 further determines whether or not any other portion of the vehicle 1 is operated as the change of the state of the vehicle 1 based on the information acquired by the acquisition unit 1142 (ST21). Specifically, the determination unit 1145 determines whether or not the state of any of the headlamp, the fog lamp, the side door, and the tailgate (backdoor) is changed. When determining that no portions are operated as the change of the state of the vehicle 1 (No at ST21), the determination unit 1145 returns the processing to ST1.

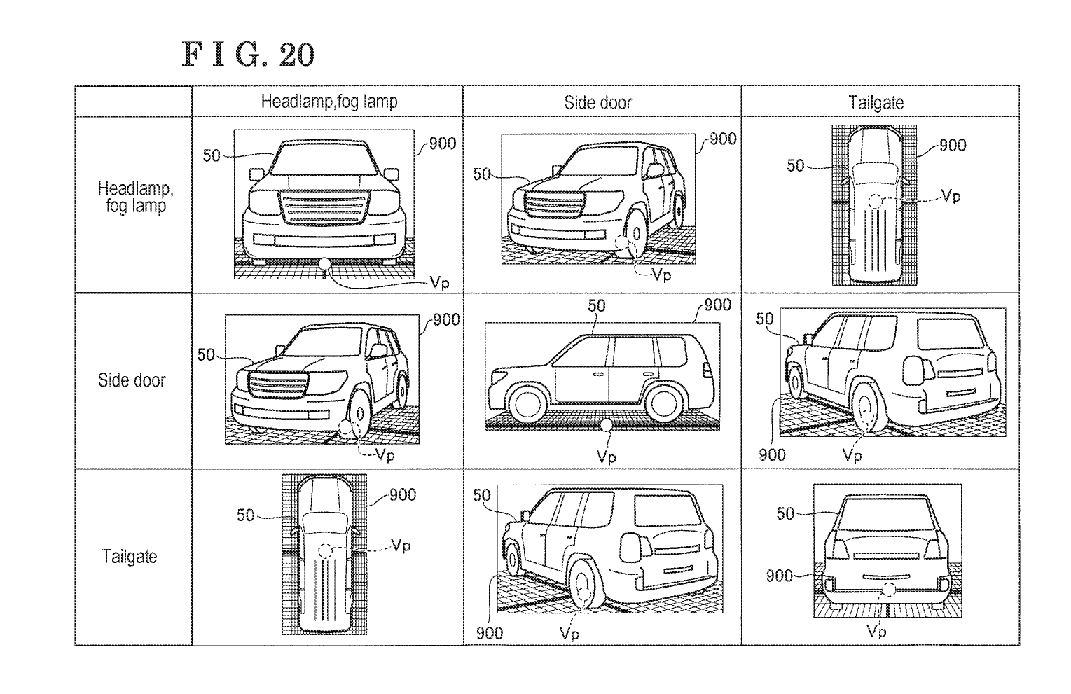

In a case where the determination unit 1145 determines that the portion of the vehicle 1 is operated as the change of the state of the vehicle 1 (Yes at ST21), the identification unit 147 identifies the viewpoint with which the part of the icon 50 corresponding to the aforementioned portion of the vehicle 1 is displayable (ST22). As illustrated in FIG. 20, the storage unit 1150 correlates the respective portions of the vehicle 1 operated as the change of the state of the vehicle 1 and the respective parts of the icon 50 corresponding to the aforementioned portions and stores such correlated information.

In a case where the plural portions of the vehicle 1 are operated as the change of the state of the vehicle 1 as illustrated in FIG. 20, combinations of such plural portions of the vehicle 1 and the viewpoints with which the parts of the icon 50 corresponding to the aforementioned plural portions of the vehicle 1 are displayable (i.e., appear on the screen) are correlated to one another. A vertical row and a horizontal row in FIG. 20 indicate combinations of the plural portions of the vehicle 1 operated as the change of the state of the vehicle 1. In a case where the portion of the vehicle 1 shown in the vertical row and the portion of the vehicle 1 shown in the horizontal row are the same, the viewpoint for displaying the single portion of the vehicle 1 operated as the change of the state of the vehicle 1 is indicated.

For example, in a case where the state of the headlamp or the fog lamp of the vehicle 1 is changed and the state of the side door and the tailgate is not changed, the icon 50 with the forward viewpoint is correlated as the viewpoint for display. In addition, in a case where the state of the headlamp or the fog lamp is changed and the state of the side door is also changed, the icon 50 with the obliquely forward viewpoint is correlated as the viewpoint for display, for example.

In a case where the viewpoint of the 3D view 900 is changed, the position of a gaze point Vp on the 3D view 900 is not changed.

The display control unit 1146 then determines whether or not the 3D view 900 is presently displayed at the display device 8 (ST23). In a case where the 3D view 900 is presently displayed at the display device 8 (Yes at ST23), the display control unit 1146 determines whether or not the viewpoint of the 3D view 900 presently displayed is the viewpoint identified by the identification unit 147 (ST24). In a case the viewpoint of the 3D view presently displayed is the viewpoint identified by the identification unit 147 (Yes at ST24), the display control unit 1146 continues the display of the 3D view presently displayed and the present processing is terminated.

In a case where the viewpoint of the 3D view 900 presently displayed is not the viewpoint identified by the identification unit 147, the display control unit 1146 switches the viewpoint of the 3D view 900 to the viewpoint identified by the identification unit 147 (ST25). In addition, the display control unit 1146 continuously changes the viewpoint of the 3D view 900 so that the 3D view is rotated when switching the viewpoint between a time period before the viewpoint is switched and after the viewpoint is switched. The aforementioned display is called a moving view. The display control unit 1146 displays the moving view where the viewpoint is moved in a state where the gaze point Vp is fixed, so that the display for observing a portion which is given attention by the gaze point Vp from various directions is available. The display control unit 1146 may smoothly display the change of the 3D view 900 with the change of the viewpoint and decrease uncomfortable feeling of the user on the change of the image.

Next, the display control unit 1146 changes the state of the icon 50 on the 3D view 900 so as to conform to the change of the state of the vehicle 1 (ST26). Specifically, the display control unit 1146 changes the state of the part of the icon 50 corresponding to the portion of the vehicle 1 operated as the change of the state of the vehicle 1. For example, in a case where the headlamp of the vehicle 1 is turned on, the display control unit 1146 changes the headlamp of the icon 50 to be turned on.

The determination unit 1145 then determines whether or not the change of the state of the vehicle 1 is finished on a basis of the information acquired by the acquisition unit 1142 (ST27). In a case where the determination unit 1145 determines that the change of the state of the vehicle 1 is not finished (No at ST27), the display control unit 1146 maintains the display of the 3D view 900 with the viewpoint after being switched (i.e., the viewpoint obtained at ST25). In a case where the determination unit 1145 determines that the change of the state of the vehicle 1 is finished (Yes at ST27), the display control unit 1146 returns the viewpoint of the 3D view 900 to the viewpoint before being switched (ST28).

In a case of the change of the state of the vehicle 1 in a state where the 3D view is not displayed (No at ST23), the display control unit 146 displays the 3D view 900 with the viewpoint identified by the identification unit 147 at the display device (ST29). The display control unit 1146 then changes the state of the icon 50 on the 3D view 900 based on the change of the state of the vehicle 1 (ST30).

The determination unit 1145 determines whether or not the change of the state of the vehicle 1 is finished on a basis of the information acquired by the acquisition unit 1142 (ST31). In a case where the determination unit 1145 determines that the change of the state of the vehicle 1 is not finished (No at ST31), the display control unit 1146 maintains the display of the 3D view 900. In a case where the determination unit 1145 determines that the change of the state of the vehicle 1 is finished (Yes at ST31), the display control unit 1146 returns the screen of the display device 8 to the screen displayed before the state of the vehicle 1 is changed (ST32). At this time, the present processing of the flowchart is terminated.

According to the ECU 14 of the fifth modified example, in a case where the plural portions of the vehicle 1 are operated as the change of the state of the vehicle 1, the icon 50 is displayed at the display device 8 with the viewpoint with which the plural parts of the icon 50 corresponding to the aforementioned plural portions of the vehicle 1 are displayable (i.e., appear at the display device 8). Therefore, according to the ECU 14 of the fifth modified example, in addition to the effects of the fourth modified example, the user may recognize the change of the vehicle 1 even when the aforementioned plural portions of the vehicle 1 are operated.

In addition, according to the ECU 14 of the fifth modified example, the plural portions of the vehicle 1 operated as the change of the state of the vehicle 1 include at least one of the headlamp, the fog lamp, the side door, and the tailgate (backdoor). The aforementioned portions are portions of which states may be frequently changed or of which changes may be difficult to be recognized by the driver. Thus, the portions of the vehicle 1 of which states are desired to be recognized by the user are displayable.

The operation of the identification unit 147 may be performed by the display control unit 1146. In the fifth modified example, the determination unit 1145 separately determines the change of the vehicle height and the change of the other items (portions). Alternatively, the determination unit 1145 may determine the change of the vehicle height and the change of the other items (portions) at one time.

According to the aforementioned embodiments and modified examples, a surroundings monitoring apparatus (ECU 14) includes a display control unit 14d which displays a state where a vehicle height serving as a height of a vehicle 1 is changing on a screen of a display device 8 in a case where the vehicle height is changing.

Accordingly, a user of the vehicle 1 may easily recognize that the height of the vehicle 1 is changing.

According to the aforementioned embodiments and modified examples, the display control unit 14d displays on the screen of the display device 8 at least one of a first vehicle image (icon, icon 50) showing the vehicle 1 at a first position on the screen corresponding to the vehicle height before change and a second vehicle image (icon, icon 52) showing the vehicle 1 at a second position on the screen corresponding to the vehicle height after change, and displays a third vehicle image (ghost 51) showing the vehicle 1 between the first position and the second position on the screen.

Accordingly, the user may easily recognize that the height of the vehicle 1 is changing.

According to the aforementioned embodiments and modified examples, the display control unit 14d moves the ghost 51 in a direction where the vehicle height is changing until the vehicle height reaches a target height.

Accordingly, the user may easily realize that the height of the vehicle 1 is increasing or decreasing, for example.

According to the aforementioned embodiments and modified examples, the display control unit 14d repeatedly moves the ghost 51 between the first position and the second position on the screen in the direction where the vehicle height is changing until the vehicle height reaches the target height.

Accordingly, the user may easily realize that the height of the vehicle 1 is changing and the changing direction of the vehicle height.

According to the aforementioned embodiments and modified examples, the surroundings monitoring apparatus further includes an acquisition unit 142 acquiring the vehicle height. The display control unit 14d moves the ghost 51 to the second position based on the vehicle height acquired by the acquisition unit 142.

Accordingly, the user may recognize the degree of progress of the vehicle height change.

According to the aforementioned embodiments and modified examples, the display control unit 14d displays the ghost 51 on a first image (a 3D view 90) including the icon 50 in a case where the 3D view 90 is displayed on the screen at a time the change of the vehicle height is started.

Accordingly, the change of the height of the vehicle 1 is displayed on the screen without changing the screen which is initially viewed by the user.

According to the aforementioned embodiments and modified examples, the display control unit 14d displays a third image (a bar 93) including one of the icon 50 and the icon 52 on the screen in a case where a second image (a camera view 91, an overhead view image 92) excluding the icon 50 is displayed on the screen at a time the change of the vehicle height is started, and displays the ghost 51 on the bar 93.

Accordingly, even in a case where the icon 50 is not displayed at a position on the screen corresponding to the vehicle height before the change at the start of the change of the vehicle height, the icon 50 and the ghost 51 may be newly displayed on the screen.

According to the aforementioned embodiments and modified examples, the display control unit 14d reduces a size of the camera view 91 or the overhead view image 92 in a stepwise manner in a state where the display of the camera view 91 or the overhead view image 92 on the screen is maintained in a case where the bar 93 is displayed on the screen, and the bar 93 is displayed in a stepwise manner at an area which appears on the screen because of the reduction of the camera view 91 or the overhead view image 92.

Accordingly, the user may easily recognize the display showing the change of the vehicle height on the bar 93 which is newly displayed.

According to the aforementioned embodiments and modified examples, the display control unit 14d displays the ghost 51 in a display mode different from the icon 50 and the icon 52.

Accordingly, the user may be inhibited from being confused by the icon 50 or the icon 52 displayed at the position on the screen corresponding to the height of the vehicle 1 before or after the change, and the ghost 51 displayed on the screen during the change of the height of the vehicle

According to the aforementioned embodiments and modified examples, the display control unit 14d moves a position of an index line on the screen based on a height of an imaging unit 15 obtained after the vehicle height is changed to a target height, the imaging unit 15 being mounted at the vehicle 1, in a case where the index line is displayed on the screen at a time the change of the vehicle height is started.

Accordingly, a difference or a displacement of a display position of the index line on the screen caused by the change of the height of the imaging unit 15 based on the change of the vehicle height is correctable.

According to the aforementioned embodiments and modified examples, the surroundings monitoring apparatus further includes an image processing unit 144 generating the second image by converting a captured image captured by an imaging unit 15 mounted at the vehicle 1 with a predetermined conversion content. The second image is an overhead view image 92 viewing surroundings of the vehicle 1 from an upper side. The image processing unit 144 generates the overhead view image after the vehicle height is changed to a target height, the overhead view image being obtained by converting the captured image with the predetermined conversion content based on a height of the imaging unit 15 after the vehicle height is changed.

Accordingly, a torsion of the overhead view image 92 caused by the change of the height of the imaging unit 15 because of the change of the vehicle height may be eliminated.

According to the aforementioned embodiments and modified examples, the display control unit 14d adjusts the icon 50 (three-dimensional image) showing the vehicle 1 to conform to a change of a state of the vehicle 1, and displays the adjusted icon 50 with a viewpoint with which a part of the icon 50 corresponding to a portion of the vehicle 1 operated as the change of the state of the vehicle 1 is displayable.

Accordingly, the user may recognize the change of the state of the vehicle 1 based on the icon 50 displayed at the display device 8 in a case of the change of the state of the vehicle 1.

According to the aforementioned embodiments and modified examples, the display control unit 14d displays an image including the icon 50 in a case where the icon 50 is inhibited from being displayed at the display device 8 at a time of the change of the state of the vehicle 1.

Accordingly, the user may further easily recognize the change of the state of the vehicle 1 by the display of the icon 50 obtained by screen transition in a case of the change of the state of the vehicle 1.

According to the aforementioned embodiments and modified examples, the display control unit 14d displays the icon 50 with a viewpoint from one of an obliquely upper side and a lateral side at a time of the change of the state of the vehicle 1.

Accordingly, the user may recognize the change of the vehicle height by a change of a vertical length of the icon 50 representing the vehicle 1.

According to the aforementioned embodiments and modified examples, the surroundings monitoring apparatus further includes an identification unit 147 identifying a viewpoint of the icon 50 with which plural parts of the icon 50 corresponding to plural portions of the vehicle 1 operated as the change of the state of the vehicle 1 are displayable in a case where the plural portions of the vehicle 1 are operated while the vehicle height is changing. The display control unit 14d displays the icon 50 with a viewpoint identified by the identification unit 147 at the display device 8.

Accordingly, even in a case where the plural portions of the vehicle 1 are operated as the change of the state of the vehicle 1, the user may recognize each of the portions of the vehicle 1 as the change of the state of the vehicle 1.

According to the aforementioned embodiments and modified examples, the plural portions of the vehicle 1 operated as the change of the state of the vehicle 1 include at least one of a headlamp, a fig lamp, a side door, and a tailgate.

Accordingly, the portions of the vehicle 1 of which states are desired to be recognized by the user are displayable.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A surroundings monitoring apparatus comprising a display control unit which displays a state where a vehicle height serving as a height of a vehicle is changing on a screen of a display portion in a case where the vehicle height is changing.

2. The surroundings monitoring apparatus according to claim 1, wherein the display control unit displays on the screen of the display portion at least one of a first vehicle image showing the vehicle at a first position on the screen corresponding to the vehicle height before change and a second vehicle image showing the vehicle at a second position on the screen corresponding to the vehicle height after change, and displays a third vehicle image showing the vehicle between the first position and the second position on the screen.

3. The surroundings monitoring apparatus according to claim 2, wherein the display control unit moves the third vehicle image in a direction where the vehicle height is changing until the vehicle height reaches a target height.

4. The surroundings monitoring apparatus according to claim 3, wherein the display control unit repeatedly moves the third vehicle image between the first position and the second position on the screen in the direction where the vehicle height is changing until the vehicle height reaches the target height.

5. The surroundings monitoring apparatus according to claim 2, further comprising an acquisition unit acquiring the vehicle height, wherein the display control unit moves the third vehicle image to the second position based on the vehicle height acquired by the acquisition unit.

6. The surroundings monitoring apparatus according to claim 3, further comprising an acquisition unit acquiring the vehicle height, wherein the display control unit moves the third vehicle image to the second position based on the vehicle height acquired by the acquisition unit.

7. The surroundings monitoring apparatus according to claim 2, wherein the display control unit displays the third vehicle image on a first image including the first vehicle image in a case where the first image is displayed on the screen at a time the change of the vehicle height is started.

8. The surroundings monitoring apparatus according to claim 2, wherein the display control unit displays a third image including one of the first vehicle image and the second vehicle image on the screen in a case where a second image excluding the first vehicle image is displayed on the screen at a time the change of the vehicle height is started, and displays the third vehicle image on the third image.

9. The surroundings monitoring apparatus according to claim 8, wherein the display control unit reduces a size of the second image in a stepwise manner in a state where the display of the second image on the screen is maintained in a case where the third image is displayed on the screen, and the third image is displayed in a stepwise manner at an area which appears on the screen because of the reduction of the second image.

10. The surroundings monitoring apparatus according to claim 2, wherein the display control unit displays the third vehicle image in a display mode different from the first vehicle image and the second vehicle image.

11. The surroundings monitoring apparatus according to claim 2, wherein the display control unit moves a position of an index line on the screen based on a height of an imaging unit obtained after the vehicle height is changed to a target height, the imaging unit being mounted at the vehicle, in a case where the index line is displayed on the screen at a time the change of the vehicle height is started.

12. The surroundings monitoring apparatus according to claim 8, further comprising an image processing unit generating the second image by converting a captured image captured by an imaging unit mounted at the vehicle with a predetermined conversion content, wherein
the second image is an overhead view image viewing surroundings of the vehicle from an upper side,
the image processing unit generates the overhead view image after the vehicle height is changed to a target height, the overhead view image being obtained by converting the captured image with the predetermined conversion content based on a height of the imaging unit after the vehicle height is changed.

13. The surroundings monitoring apparatus according to claim 1, wherein the display control unit adjusts a three-dimensional image showing the vehicle to conform to a change of a state of the vehicle, and displays the adjusted three-dimensional image with a viewpoint with which a part of the three-dimensional image corresponding to a portion of the vehicle operated as the change of the state of the vehicle is displayable.

14. The surroundings monitoring apparatus according to claim 13, wherein the display control unit displays an image including the three-dimensional image in a case where the three-dimensional image is inhibited from being displayed at the display unit at a time of the change of the state of the vehicle.

15. The surroundings monitoring apparatus according to claim 13, wherein the display control unit displays the three-dimensional image with a viewpoint from one of an obliquely upper side and a lateral side at a time of the change of the state of the vehicle.

16. The surroundings monitoring apparatus according to claim 13, further comprising an identification unit identifying a viewpoint of the three-dimensional image with which a plurality of parts of the three-dimensional image corresponding to a plurality of portions of the vehicle operated as the change of the state of the vehicle is displayable in a case where the plurality of portions of the vehicle is operated while the vehicle height is changing, wherein
the display control unit displays the three-dimensional image with a viewpoint identified by the identification unit at the display unit.

17. The surroundings monitoring apparatus according to claim 16, wherein the plurality of portions of the vehicle operated as the change of the state of the vehicle includes at least one of a headlamp, a fig lamp, a side door, and a tailgate.
